(19) United States
(12) Patent Application Publication
(10) Pub. No.: US 2018/0032049 A1
(43) Pub. Date: Feb. 1, 2018

(54) ROBOT CONTROL DEVICE, ROBOT, AND ROBOT SYSTEM

(71) Applicant: Seiko Epson Corporation, Tokyo (JP)

(72) Inventor: Mitsuhiro INAZUMI, Shiojiri (JP)

(21) Appl. No.: 15/657,539

(22) Filed: Jul. 24, 2017

(30) Foreign Application Priority Data
Jul. 29, 2016 (JP) 2016-149432

(51) Int. Cl. G05B 19/042; G05B 19/414; B25J 9/16

(52) U.S. Cl. CPC G05B 19/0426; B25J 9/1633; G05B 19/414; G06F 19/00

(57) ABSTRACT

A robot control device includes a processor that is configured to execute computer-executable instruction so as to control a robot that is capable of displacing a control target of a robot in a plurality of directions, wherein the processor is configured to cause the robot to perform displacement actuation of displacing the control target in a direction different from a direction of the external force among the plurality of directions in a case where a force detector detects external force.

### BACKGROUND

### 1. Technical Field

The present invention relates to a robot control device, a robot, and a robot system.

### 2. Related Art

Research and development of a technology, in which a robot is controlled, based on external force detected by a force detector, has been performed.

In this respect, when the robot presses a workpiece against a rotating body so as to polish the workpiece, a processing robot system that corrects a target orbit or speed in or at which the workpiece moves, based on a change in force or moment received by the workpiece pressed against the rotating body from the rotating body, has been known (see JP-A-2011-41992).

However, in a case where friction force from the rotating body acts on the workpiece, the processing robot system causes the workpiece to rotate depending on the friction force. In other words, in this case, it is not possible for the processing robot system to maintain a state in which the workpiece is pressed against the rotating body. As a result, it is difficult for the processing robot system to perform processing on the workpiece with high accuracy.

### SUMMARY

An aspect of the invention is directed to a robot control device comprising: a processor that is configured to execute computer-executable instruction so as to control a robot that is capable of displacing a control target of a robot in a plurality of directions, wherein the processor is configured to cause the robot to perform displacement actuation of displacing the control target in a direction different from a direction of the external force among the plurality of directions in a case where a force detector detects external force.

In this configuration, in the case where the force detector detects the external force, the robot control device causes the robot to perform the displacement actuation of displacing the control target in the direction different from the direction of the external force among the plurality of directions. In this manner, the robot control device may cause the robot to highly accurately perform work of applying the external force in a direction different from a direction parallel to the direction in which the control target is displaced.

In another aspect of the invention, the robot control device may be configured such that the processor is configured to cause the robot to perform the displacement actuation depending on the predetermined work in a case where the robot is caused to perform predetermined work.

In this configuration, in the case where the robot is caused to perform the predetermined work, the robot control device causes the robot to perform the displacement actuation depending on the predetermined work. In this manner, the robot control device may cause the robot to highly accurately perform the work of applying the external force in the direction different from the direction parallel to the direction in which the control target is displaced, based on the displacement actuation depending on the predetermined work.

In another aspect of the invention, the robot control device may be configured such that the processor is configured to cause the robot to perform, as the predetermined work, work of fitting a first target object into a second target object into which the first target object is fitted.

In this configuration, the robot control device causes the robot to perform, as the predetermined work, the work of fitting the first target object into the second target object into which the first target object is fitted. In this manner, the robot control device may cause the robot to highly accurately perform the work of applying the external force in the direction different from the direction parallel to the direction in which the control target is displaced, based on the displacement actuation depending on the work of fitting the first target object into the second target object.

In another aspect of the invention, the robot control device may be configured such that the displacement actuation includes at least one of first actuation of translating the control target based on translational force of the external force, second actuation of rotating the control target based on the translational force, third actuation of translating the control target based on rotation moment of the external force, and fourth actuation of rotating the control target based on rotation moment.

In this configuration, in the case where the force detector detects the external force, the robot control device causes the robot to perform the displacement actuation that includes at least one of the first actuation, the second actuation, the third actuation, and the fourth actuation, as the displacement actuation of displacing the control target in the direction different from the direction of the external force among the plurality of directions. In this manner, the robot control device may cause the robot to highly accurately perform the work of applying the external force in the direction different from the direction parallel to the direction in which the control target is displaced, based on the displacement actuation that includes at least one of the first actuation, the second actuation, the third actuation, and the fourth actuation.

In another aspect of the invention, the robot control device may be configured such that the processor is configured to cause the robot to perform, as the displacement actuation, actuation based on some or all of the first actuation, the second actuation, the third actuation, and the fourth actuation.

In this configuration, the robot control device causes the robot to perform, as the displacement actuation, the actuation, based on some or all of the first actuation, the second actuation, the third actuation, and the fourth actuation. In this manner, the robot control device may cause the robot to highly accurately perform the work of applying the external force in the direction different from the direction parallel to the direction in which the control target is displaced, based on the actuation on the basis of some or all of the first actuation, the second actuation, the third actuation, and the fourth actuation.

In another aspect of the invention, the robot control device may be configured such that the processor is configured to cause the robot to perform the displacement actuation based on a result obtained from a matrix operation of a digital filter.

In this configuration, the robot control device causes the robot to perform the displacement actuation based on the result obtained from the matrix operation of the digital filter. In this manner, the robot control device may cause the robot to highly accurately perform the work of applying the external force in the direction different from the direction parallel to the direction in which the control target is displaced, based on the result obtained from the matrix operation of the digital filter.

Another aspect of the invention is directed to a robot that is controlled by the robot control device described above.

In this configuration, in the case where the force detector detects the external force, the robot performs the displacement actuation of displacing the control target in the direction different from the direction of the external force among the plurality of directions. In this manner, the robot may highly accurately perform the work of applying the external force in the direction different from the direction parallel to the direction in which the control target is displaced.

Another aspect of the invention is directed to a robot system including the robot control device described above; and the robot described above.

In this configuration, in the case where the force detector detects the external force, the robot system causes the robot to perform the displacement actuation of displacing the control target in the direction different from the direction of the external force among the plurality of directions. In this manner, the robot system may cause the robot to highly accurately perform the work of applying the external force in the direction different from the direction parallel to the direction in which the control target is displaced.

As described above, in the case where the force detector detects the external force, the robot control device and the robot system cause the robot to perform the displacement actuation of displacing the control target in the direction different from the direction of the external force among the plurality of directions. In this manner, the robot control device and the robot system may cause the robot to highly accurately perform the work of applying the external force in the direction different from the direction parallel to the direction in which the control target is displaced.

In addition, in the case where the force detector detects the external force, the robot performs the displacement actuation of displacing the control target in the direction different from the direction of the external force among the plurality of directions. In this manner, the robot may highly accurately perform the work of applying the external force in the direction different from the direction parallel to the direction in which the control target is displaced.

### BRIEF DESCRIPTION OF THE DRAWINGS

The invention will be described with reference to the accompanying drawings, wherein like numbers reference like elements.

FIG. 1 is a diagram illustrating an example of a configuration of a robot system according to an embodiment.

FIG. 2 is a diagram illustrating an example of states of a first target object and a second target object at a timing before the first target object comes into contact with the second target object in chamferless fitting work between the first target object and the second target object.

FIG. 3 is a diagram illustrating an example of states of the first target object and the second target object at a timing immediately after the first target object comes into contact with the second target object in the chamferless fitting work between the first target object and the second target object.

FIG. 4 is a diagram illustrating an example of states of the first target object and the second target object at a timing after the first target object is caused to rotate in accordance with force control in the related art in the chamferless fitting work between the first target object and the second target object.

FIG. 5 is a diagram illustrating an example of a hardware configuration of a robot control device.

FIG. 6 is a diagram illustrating an example of a functional configuration of the robot control device.

FIG. 7 is a flowchart illustrating an example of flow of a process in which the robot control device causes the robot to perform predetermined work.

FIG. 8 is a diagram illustrating an example of a digital filter converted from a motion equation expressed by Equation (1) by an impulse•invariance method.

FIG. 9 is a diagram illustrating an example of Equation (8).

FIG. 10 is a diagram illustrating Equation (9).

FIG. 11 is a diagram illustrating an example of a state in which force is applied from the second target object to a region in a positive direction of a Z axis in a force-detection coordinate system, in force control in the example.

FIG. 12 is a diagram illustrating an example of states of the first target object and the second target object after the first target object illustrated in FIG. 11 is translated in a direction.

FIG. 13 is a diagram illustrating an example of a state in which the first target object is fitted into a fitting portion.

FIG. 14 is a diagram illustrating an example of a configuration of a robot system according to a modification example of the embodiment.

### DESCRIPTION OF EXEMPLARY EMBODIMENTS

### Embodiment

Hereinafter, an embodiment of the invention will be described with reference to the figures.

### Configuration of Robot System

First, a configuration of a robot system 1 is described.

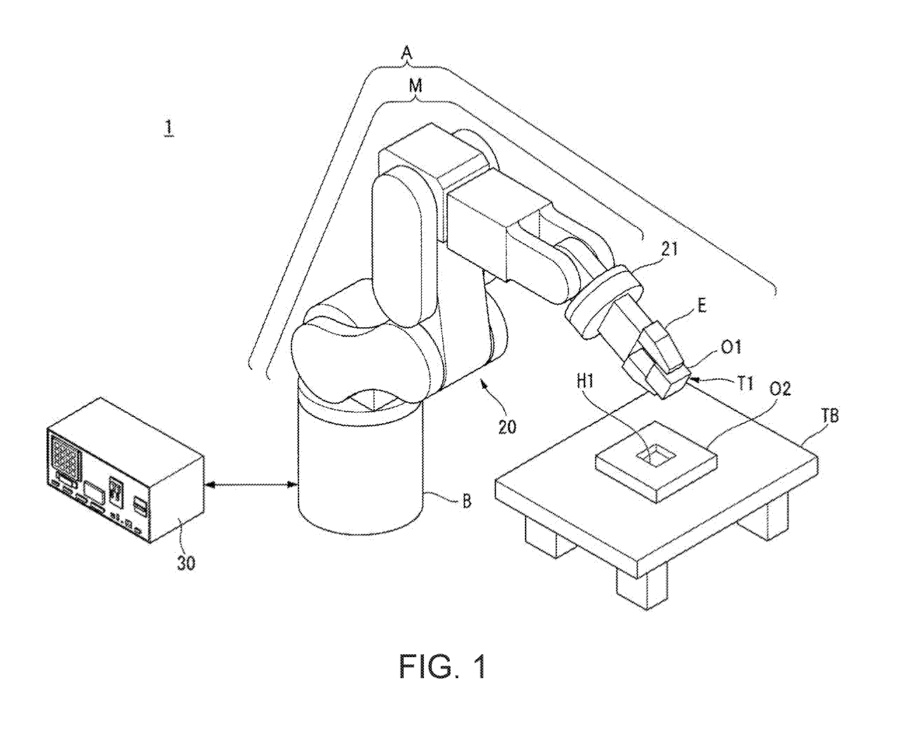

FIG. 1 is a diagram illustrating an example of the configuration of the robot system 1 according to the embodiment. The robot system 1 includes a robot 20 and a robot control device 30.

The robot 20 is a single-arm robot that includes an arm A and a support base B that supports the arm A. The single-arm robot in the example is a robot that includes one arm such as the arm A. Note that the robot 20 may be a multi-arm robot, instead of the single-arm robot. The multi-arm robot is a robot that includes two or more arms (for example, two or more arms A). Note that a robot that includes two arms is also referred to as a dual-arm robot among the multi-arm robots. In other words, the robot 20 may be the dual-arm robot that includes two arms or may be the multi-arm robot that includes three or more arms (for example, three or more arms A). In addition, the robot 20 may be another robot such as a SCARA robot, a cartesian coordinate robot, or a cylindrical robot. The cartesian coordinate robot is, for example, a gantry robot.

The arm A includes an end effector E, a manipulator M, and a force detector 21.

The end effector E of the robot 11 in the example is an end effector that includes a finger portion which is capable of gripping an object. Note that the end effector E may be an end effector that is capable of holding an object by suction of air, magnetic force, a jig, or the like, or another end effector, instead of the end effector including the finger portion.

The end effector E is connected to the robot control device 30 via a cable so as to be capable of communicating with the robot control device. In this manner, the end effector E is actuated based on a control signal acquired from the robot control device 30. Note that the wired communication via the cable is performed in accordance with the standards such as the Ethernet (registered trademark) or a USB. In addition, the end effector E may be configured to be connected to the robot control device 30 through wireless communication that is performed in accordance with the communication standards such as Wi-Fi (registered trademark).

The manipulator M includes six joints. In addition, the six joints include respective actuators (not illustrated). In other words, the arm A including the manipulator M is a six-axis vertical multijoint type of arm. The arm A is actuated in a degree of freedom of six axes through actuation performed in cooperation with the support base B, the end effector E, the manipulator M, and the respective actuators of the six joints included in the manipulator M. Note that the arm A may be configured to be actuated in a degree of freedom of five or less axes, or may be configured to be actuated in a degree of freedom of seven or more axes.

The six actuators (included in the respective joints) which are included in the manipulator M are connected to the robot control device 30 via respective cables, so as to be capable of communicating with the robot control device. In this manner, the actuators cause the manipulator M to be actuated, based on a control signal acquired from the robot control device 30. Note that the wired communication via the cables is performed in accordance with the standards such as the Ethernet (registered trademark) or a USB. In addition, some or all of the six actuators included in the manipulator M may be configured to be connected to the robot control device through wireless communication that is performed in accordance with the communication standards such as Wi-Fi (registered trademark).

The force detector 21 is provided between the end effector E and the manipulator M. For example, the force detector 21 is a force sensor. The force detector 21 detects external force that is applied to a control target. The control target in the example is the end effector E or an object gripped by the end effector E in some cases. Hereinafter, as an example, a case where a first target object O1 gripped by the end effector E in advance is the control target will be described. The first target object O1 will be described below. The external force includes translational force of translating the first target object O1 and rotation moment (torque) of causing the first target object O1 to rotate. Specifically, the external force includes three types of translational force of X translational force as force of translating the first target object O1 in a direction parallel to an X axis in a force-detection coordinate system FC as a three-dimensional local coordinate system associated with the force detector 21, Y translational force as force of translating the first target object O1 in a direction parallel to a Y axis in the force-detection coordinate system FC, and Z translational force as force of translating the first target object O1 in a direction parallel to a Z axis in the force-detection coordinate system FC. In addition, the external force includes three types of rotation moment of W rotation moment as rotation moment of rotating the first target object O1 in a direction parallel to a W axis in the force-detection coordinate system FC, V rotation moment as rotation moment of rotating the first target object O1 in a direction parallel to a V axis in the force-detection coordinate system FC, and U rotation moment as rotation moment of rotating the first target object O1 in a direction parallel to a U axis in the force-detection coordinate system FC. Here, the W axis means a coordinate axis representing a rotating direction and a rotating angle obtained when the first target object O1 rotates around the X axis. The V axis means a coordinate axis representing a rotating direction and a rotating angle obtained when the first target object O1 rotates around the Y axis. The U axis means a coordinate axis representing a rotating direction and a rotating angle obtained when the first target object O1 rotates around the Z axis. The force detector 21 outputs, to the robot control device 30 through the communication, force-detection information including, as output values, values indicating types of detected external force (that is, the respective three types of translational force and three types of rotation moment).

The force-detection information is used in force control by the robot control device 30, as control performed based on the force-detection information of the arm A. For example, the force control is compliant motion control such as impedance control. Note that the force detector 21 may be another sensor such as a torque sensor that detects a value indicating external force applied to the control target.

The force detector 21 is connected to the robot control device 30 via a cable so as to be capable of communicating with the robot control device. For example, the wired communication via the cable is performed in accordance with the standards such as the Ethernet (registered trademark) or a USB. In addition, the force detector 21 and the robot control device 30 may be configured to be connected to each other through wireless communication that is performed in accordance with the communication standards such as Wi-Fi (registered trademark).

The robot control device 30 in the example is a controller that controls the robot (causes the robot to be actuated). The robot control device 30 acquires the force-detection information from the force detector 21. The robot control device 30 causes the manipulator M to be actuated in accordance with the force control based on the acquired force-detection information and causes the robot 20 to perform predetermined work. The predetermined work in the example is work of fitting the first target object O1 into a second target object O2 into which the first target object O1 is fitted. Note that the predetermined work may be other work instead of the work described above.

The first target object O1 is an object that is fitted into the second target object O2, and, for example, an industrial component or member such as a plate, a screw, or a bolt that is assembled into a product. In FIG. 1, for simplification of the figure, the first target object O1 is illustrated as a rectangular parallelepiped object. Note that the first target object O1 may be another object such as a daily commodity or a living body, instead of the industrial component or member. In addition, the first target object O1 has another shape, instead of the rectangular parallelepiped shape.

Here, in the example illustrated in FIG. 1, the first target object O1 is gripped by the end effector E in advance as described above. Note that the robot 20 may be configured to grip the first target object O1 loaded in a supply region (not illustrated) and to perform, as the predetermined work, the work of fitting the gripped first target object O1 into the second target object O2.

The second target object O2 is an object into which the first target object O1 is fitted, and, for example, an industrial component or member such as a plate, a screw, or a bolt that is assembled into a product. The second target object O2 is provided with a fitting portion H1 into which the first target object O1 is fitted. In FIG. 1, for simplification of the figure, the second target object O2 is illustrated as a plate-shaped object in which the fitting portion H1 is formed. Note that the second target object O2 may be another object such as a daily commodity or a living body, instead of the industrial component or member. In addition, the second target object O2 has another shape, instead of the plate shape.

Here, in the example illustrated in FIG. 1, the second target object O2 is loaded on the top surface of a workbench TB. For example, the workbench TB is a base such as a table. Note that the workbench TB may be another base as long as it is possible to load the second target object O2 instead of a table.

Outline of Process in Which Robot Control Device Causes Robot to Perform Predetermined Work

Hereinafter, an outline of a process in which the robot control device 30 causes the robot 20 to perform the predetermined work will be described.

The robot control device 30 sets a control point T1, which moves along with the end effector E, at a position associated with the end effector E in advance. The position associated with the end effector E in advance is a position in a robot coordinate system RC. For example, the position associated with the end effector E in advance is a position of the center of gravity of the first target object O1 gripped by the end effector E. Hence, it is possible to refer external force applied to the first target object O1 of the control target in the example as external force applied to the control point T1. In addition, as described above, the control point T1 moves along with the end effector E. Therefore, the control point T1 moves along with the first target object O1 gripped by the end effector E in advance. With such a reason, in the example, the position and a posture of the control point T1 indicate a position and a posture of the first target object O1. Note that the position and the posture of the first target object O1 maybe configured to be indicated by another position and another posture.

For example, the control point T1 is a tool center point (TCP). Note that the control point T1 may be another virtual point such as a virtual point associated with a part of the arm A, instead of the TCP. In other words, the control point T1 may be configured to be set to a position in another region of the end effector E or may be configured to be set to any position associated with the manipulator M, instead of the position associated with the end effector E.

The control point T1 is associated with control-point positional information as information indicating the position of the control point T1 and control-point posture information as information indicating the posture of the control point T1 . The position is a position in the robot coordinate system RC. The posture is a posture in the robot coordinate system RC. Note that the control point T1 may be configured to be associated with other information. When the robot control device 30 designates (determines) the control-point positional information and the control-point posture information, the position and the posture of the control point T1 are determined. The position and the posture are a position and a posture in the robot coordinate system RC. The robot control device 30 causes the arm A to be actuated such that the position of the control point T1 is coincident with the position indicated in the control-point positional information designated by the robot control device 30, and the posture of the control point T1 is coincident with the posture indicated in the control-point posture information designated by the robot control device 30. Hereinafter, for convenience of description, the position indicated in the control-point positional information designated by the robot control device is referred to as a target position, and the posture indicated in the control-point posture information designated by the robot control device 30 is referred to as a target posture in the following description. In other words, the robot control device 30 designates the control-point positional information and the control-point posture information, and thereby the robot control device causes the robot 20 to be actuated such that the position and the posture of the control point T1 are coincident with the target position and the target posture.

In the example, the position of the control point T1 is indicated by a position of the origin of a control-point coordinate system TC in the robot coordinate system RC. In addition, the posture of the control point T1 is indicated by a direction of coordinate axes of the control-point coordinate system TC in the robot coordinate system RC. The control-point coordinate system TC is a three-dimensional local coordinate system associated with the control point T1 so as to move along with the control point T1.

The robot control device 30 sets the control point T1 based on control-point setting information input from a user in advance. For example, the control-point setting information is information indicating relative positions and postures with respect to the position and posture of the center of gravity of the end effector E and the position and posture of the control point T1. Instead, the control-point setting information may be information indicating relative positions and postures with respect to any position and posture associated with the end effector E and the position and posture of the control point T1, may be information indicating relative positions and postures with respect to any position and posture associated with the manipulator M and the position and posture of the control point T1, or may be information indicating relative positions and postures with respect to any position and posture associated with another region of the robot 20 and the position and posture of the control point T1.

Here, the robot control device 30 in the example designates the control-point positional information and the control-point posture information, based on the external force detected by the force detector 21. In other words, the robot control device 30 changes the position and the posture of the control point T1 in accordance with the force control described above. Here, the force control in the example includes control different from the force control in the related art.

In a case where the external force detected by the force detector 21 does not satisfy predetermined conditions, a robot control device 30X that controls the robot 20 in accordance with the force control in the related art calculates, depending on the external force, a displacement amount by which the first target object O1 is displaced in a direction in which the external force is applied. Specifically, the robot control device 30X calculates, depending on the X translational force, a displacement amount by which the first target object O1 is translated in a direction in which the X translational force is applied to the first target object O1. In addition, the robot control device 30X calculates, depending on the Y translational force, a displacement amount by which the first target object O1 is translated in a direction of the Y translational force. In addition, the robot control device 30X calculates, depending on the Z translational force, a displacement amount by which the first target object O1 is translated in a direction of the Z translational force. In addition, the robot control device 30X calculates, depending on the W rotation moment, a displacement amount by which the first target object O1 rotates in a direction of the W rotation moment. In addition, the robot control device 30X calculates, depending on the V rotation moment, a displacement amount by which the first target object O1 rotates in a direction of the V rotation moment. In addition, the robot control device 30X calculates, depending on the U rotation moment, a displacement amount by which the first target object O1 rotates in a direction of the U rotation moment. The robot control device 30X changes the position and the posture of the control point T1 based on the calculated displacement amounts. Note that the robot control device 30X does not change the position and the posture of the control point T1 in a case where the external force satisfies the conditions. The conditions are conditions for the external force.

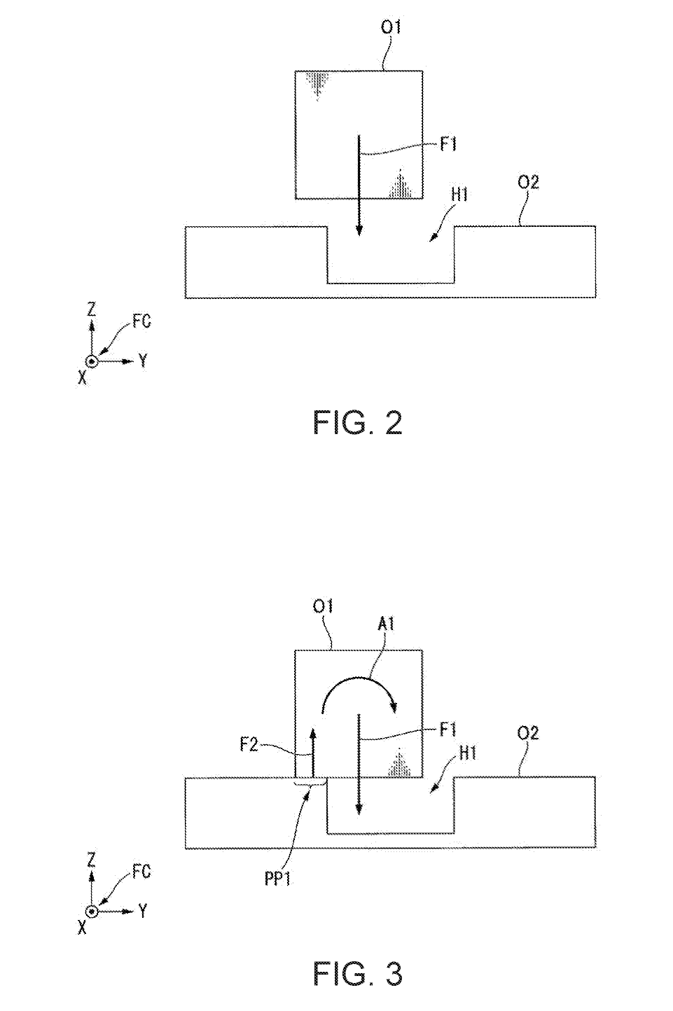

In some cases, it is not possible for the robot control device 30X that controls the robot 20 in accordance with the force control in the related art to highly accurately perform the work of applying the external force in a direction different from a direction parallel to the direction in which the first target object O1 is displaced. For example, the work is chamferless fitting work between the first target object O1 and the second target object O2 as illustrated in FIGS. 2 to 4. Note that the work includes other work such as work pushing a workpiece to a rotating member and polishing the workpiece by the robot 20, in which the external force is applied in a direction different from the direction parallel to the direction in which the robot 20 displaces an object.

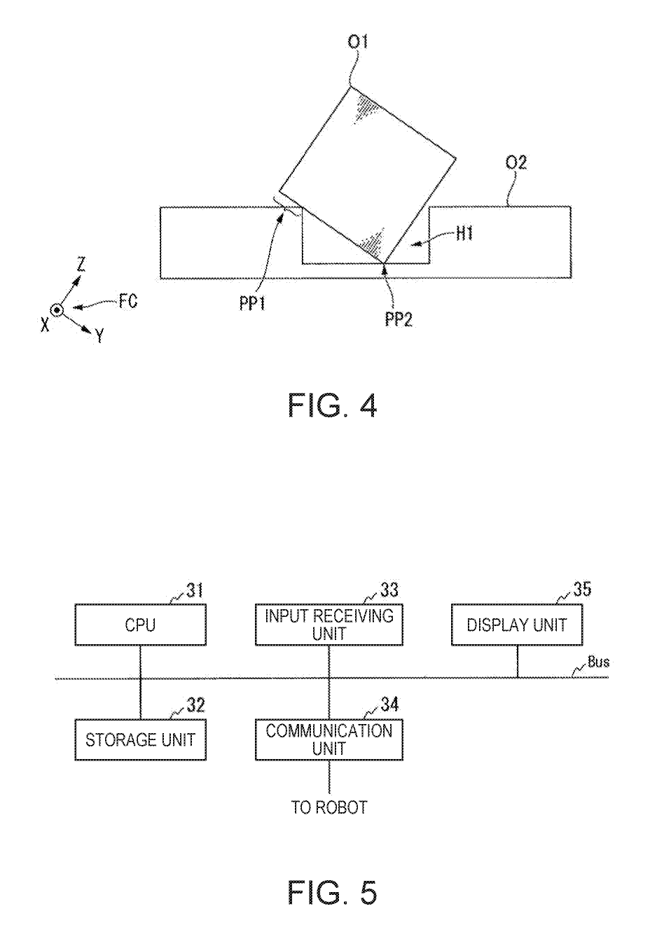

FIG. 2 is a diagram illustrating an example of states of the first target object O1 and the second target object O2 at a timing before the first target object O1 comes into contact with the second target object O2 in the chamferless fitting work between the first target object O1 and the second target object O2. FIG. 3 is a diagram illustrating an example of states of the first target object O1 and the second target object O2 at a timing immediately after the first target object O1 comes into contact with the second target object O2 in the chamferless fitting work between the first target object O1 and the second target object O2. FIG. 4 is a diagram illustrating an example of states of the first target object O1 and the second target object O2 at a timing after the first target object O1 is caused to rotate in accordance with the force control in the related art in the chamferless fitting work between the first target object O1 and the second target object O2. Here, as an example, a case where an XY plane in the force-detection coordinate system FC in FIGS. 2 and 3 is parallel with the top surface of the workbench TB is described. In this case, a direction, in which the first target object O1 is displaced in a case where the first target object O1 is separated from the second target object O2 from a state in which the first target object O1 is fitted into the second target object O2, is a positive direction of the Z axis in the force-detection coordinate system FC. Note that the XY plane may be nonparallel to the top surface.

Here, the chamferless fitting work between the first target object O1 and the second target object O2 in the example is work of fitting the first target object O1 into the second target object O2 in a state in which, as illustrated in FIGS. 2 to 4, the fitting portion H1 does not have chamfer at corners of the plurality of corners of the fitting portion in a surface of the second target object O2 on a surface side of a side on which the fitting of the first target object O1 is performed. In other words, in the example, all of the corners have the angle of 90°.

FIG. 2 illustrates an example of a case where the position and the posture of the first target object O1 are coincident with a predetermined standby position and standby posture. The predetermined standby position and standby posture mean a position at which it is possible to fit the first target object O1 into the fitting portion H1 by displacing the first target object O1 in a negative direction of the Z axis in the force-detection coordinate system FC. However, even in this case, the position and the posture of the first target object O1 shift from the predetermined standby position and standby posture due to an error in rigidity, assembly, or the like of members included in the robot 20, an error in calibration, or the like. The example illustrated in FIG. 2 shows a state in which the position and the posture of the first target object O1 shift from the predetermined standby position and standby posture due to such an error.

In such a state, in a case where the robot 20 applies force F1 to the first target object O1 in the negative direction of the Z axis in the force-detection coordinate system FC as illustrated in FIG. 2, the first target object is displaced in a direction of the force Fl. The first target object O1 illustrated in FIG. 2 is not fitted into the fitting portion H1 of the second target object O2 similarly to the first target object O1 illustrated in FIG. 3, but the first target object comes into contact with the second target object O2 at a position different from the fitting portion H1 of the positions thereof. In the example illustrated in FIG. 3, a region PP1 on the negative direction side of the Y axis in the force-detection coordinate system FC as a region in a surface of the first target object O1 on the negative direction side of the Z axis in the force-detection coordinate system FC comes into contact with the second target object O2. In such a case where the first target object O1 comes into contact with the second target object O2, force F2 is applied to the region PP1 from the second target object O2 in the positive direction of the Z axis as illustrated in FIG. 3. As a result, rotation moment is applied to the first target object O1 from the second target object O2 in a direction Al represented by an arrow in FIG. 3. The rotation moment is an example of the W rotation moment described above. In this case, under the force control in the related art, the first target object O1 rotates in the direction Al represented by the arrow in FIG. 3 so as to have the rotation moment of 0. As illustrated in FIG. 4, as the state in which the first target object O1 is in contact with the second target object O2 in at least a part of the region PP1 is maintained, an end portion PP2 of the first target object on the positive direction side of the Y axis in the force-detection coordinate system FC, as an end portion of a surface on the negative direction side of the Z axis in the force-detection coordinate system FC of the surface of the first target object O1 illustrated in FIG. 3, comes into contact with the bottom of the fitting portion Hl.

In the state illustrated in FIG. 4, the first target object O1 receives clockwise rotation moment (that is, the rotation moment that causes the first target object O1 to rotate in the direction A1 described above) measured when viewed from the positive direction toward the negative direction of the X axis in the force-detection coordinate system FC and counterclockwise rotation moment (that is, the rotation moment that causes the first target object O1 to rotate in a direction opposite to the direction A1 described above). As a result, it is not possible for the robot 20 to cause the first target object O1 to move in accordance with the force control in the related art in some cases. In other words, under the force control in the related art, it is not possible for the robot 20 to cause the position and the posture of the first target object O1 illustrated in FIG. 4 to be coincident with the position and the posture of the first target object O1 in the state of being fitted into the fitting portion H1.

On the other hand, in a case where the external force detected by the force detector 21 does not satisfy the predetermined conditions, the robot control device 30 that performs the force control in the example calculates a displacement amount by which the first target object O1 is displaced depending on the external force. Specifically, in this case, the robot control device 30 calculates six translational displacement amounts of a TTX translational displacement amount, a TTY translational displacement amount, a TTZ translational displacement amount, an RTX translational displacement amount, an RTY translational displacement amount, and an RTZ translational displacement amount, and six rotational displacement amounts of an RRW rotational displacement amount, an RRV rotational displacement amount, an RRU rotational displacement amount, a TRW rotational displacement amount, a TRV rotational displacement amount, and a TRU rotational displacement amount. Note that the robot control device 30 does not change the position and the posture of the control point T1 in a case where the external force satisfies the conditions. The predetermined conditions will be described below.

The TTX translational displacement amount is a total of a TTX translational displacement amount due to the X translational force, a TTX translational displacement amount due to the Y translational force, and a TTX translational displacement amount due to the Z translational force. The TTX translational displacement amount due to the X translational force means a translational displacement amount by which the first target object O1 is translated due to the X translational force in a direction parallel to the X axis in the force-detection coordinate system FC. The TTX translational displacement amount due to the Y translational force means a translational displacement amount by which the first target object O1 is translated due to the Y translational force in the direction parallel to the X axis in the force-detection coordinate system FC. The TTX translational displacement amount due to the Z translational force means a translational displacement amount by which the first target object O1 is translated due to the Z translational force in the direction parallel to the X axis in the force-detection coordinate system FC.

The TTY translational displacement amount is a total of a TTY translational displacement amount due to the X translational force, a TTY translational displacement amount due to the Y translational force, and a TTY translational displacement amount due to the Z translational force. The TTY translational displacement amount due to the X translational force means a translational displacement amount by which the first target object O1 is translated due to the X translational force in a direction parallel to the Y axis in the force-detection coordinate system FC. The TTY translational displacement amount due to the Y translational force means a translational displacement amount by which the first target object O1 is translated due to the Y translational force in the direction parallel to the Y axis in the force-detection coordinate system FC. The TTY translational displacement amount due to the Z translational force means a translational displacement amount by which the first target object O1 is translated due to the Z translational force in the direction parallel to the Y axis in the force-detection coordinate system FC.

The TTZ translational displacement amount is a total of a TTZ translational displacement amount due to the X translational force, a TTZ translational displacement amount due to the Y translational force, and a TTZ translational displacement amount due to the Z translational force. The TTZ translational displacement amount due to the X translational force means a translational displacement amount by which the first target object O1 is translated due to the X translational force in a direction parallel to the Z axis in the force-detection coordinate system FC. The TTZ translational displacement amount due to the Y translational force means a translational displacement amount by which the first target object O1 is translated due to the Y translational force in the direction parallel to the Z axis in the force-detection coordinate system FC. The TTZ translational displacement amount due to the Z translational force means a translational displacement amount by which the first target object O1 is translated due to the Z translational force in the direction parallel to the Z axis in the force-detection coordinate system

FC.

The RTX translational displacement amount is a total of an RTX translational displacement amount due to the W rotation moment, an RTX translational displacement amount due to the V rotation moment, and an RTX translational displacement amount due to the U rotation moment. The RTX translational displacement amount due to the W rotation moment means a translational displacement amount by which the first target object O1 is translated due to the W rotation moment in the direction parallel to the X axis in the force-detection coordinate system FC. The RTX translational displacement amount due to the V rotation moment means a translational displacement amount by which the first target object O1 is translated due to the V rotation moment in the direction parallel to the X axis in the force-detection coordinate system FC. The RTX translational displacement amount due to the U rotation moment means a translational displacement amount by which the first target object O1 is translated due to the U rotation moment in the direction parallel to the X axis in the force-detection coordinate system FC.

The RTY translational displacement amount is a total of an RTY translational displacement amount due to the W rotation moment, an RTY translational displacement amount due to the V rotation moment, and an RTY translational displacement amount due to the U rotation moment. The RTY translational displacement amount due to the W rotation moment means a translational displacement amount by which the first target object O1 is translated due to the W rotation moment in the direction parallel to the Y axis in the force-detection coordinate system FC. The RTY translational displacement amount due to the V rotation moment means a translational displacement amount by which the first target object O1 is translated due to the V rotation moment in the direction parallel to the Y axis in the force-detection coordinate system FC. The RTY translational displacement amount due to the U rotation moment means a translational displacement amount by which the first target object O1 is translated due to the U rotation moment in the direction parallel to the Y axis in the force-detection coordinate system FC.

The RTZ translational displacement amount is a total of an RTZ translational displacement amount due to the W rotation moment, an RTZ translational displacement amount due to the V rotation moment, and an RTZ translational displacement amount due to the U rotation moment. The RTZ translational displacement amount due to the W rotation moment means a translational displacement amount by which the first target object O1 is translated due to the W rotation moment in the direction parallel to the Z axis in the force-detection coordinate system FC. The RTZ translational displacement amount due to the V rotation moment means a translational displacement amount by which the first target object O1 is translated due to the V rotation moment in the direction parallel to the Z axis in the force-detection coordinate system FC. The RTZ translational displacement amount due to the U rotation moment means a translational displacement amount by which the first target object O1 is translated due to the U rotation moment in the direction parallel to the Z axis in the force-detection coordinate system FC.

The RRW rotational displacement amount is a total of an RRW rotational displacement amount due to the W rotation moment, an RRW rotational displacement amount due to the V rotation moment, and an RRW rotational displacement amount due to the U rotation moment. The RRW rotational displacement amount due to the W rotation moment means a rotational displacement amount by which the first target object O1 rotates due to the W rotation moment in a direction parallel to the W axis in the force-detection coordinate system FC. The RRW rotational displacement amount due to the V rotation moment means a rotational displacement amount by which the first target object O1 rotates due to the V rotation moment in the direction parallel to the W axis in the force-detection coordinate system FC. The RRW rotational displacement amount due to the U rotation moment means a rotational displacement amount by which the first target object O1 rotates due to the U rotation moment in the direction parallel to the W axis in the force-detection coordinate system FC.

The RRV rotational displacement amount is a total of an RRV rotational displacement amount due to the W rotation moment, an RRV rotational displacement amount due to the V rotation moment, and an RRV rotational displacement amount due to the U rotation moment. The RRV rotational displacement amount due to the W rotation moment means a rotational displacement amount by which the first target object O1 rotates due to the W rotation moment in a direction parallel to the V axis in the force-detection coordinate system FC. The RRV rotational displacement amount due to the V rotation moment means a rotational displacement amount by which the first target object O1 rotates due to the V rotation moment in the direction parallel to the V axis in the force-detection coordinate system FC. The RRV rotational displacement amount due to the U rotation moment means a rotational displacement amount by which the first target object O1 rotates due to the U rotation moment in the direction parallel to the V axis in the force-detection coordinate system FC.

The RRU rotational displacement amount is a total of an RRU rotational displacement amount due to the W rotation moment, an RRU rotational displacement amount due to the V rotation moment, and an RRU rotational displacement amount due to the U rotation moment. The RRU rotational displacement amount due to the W rotation moment means a rotational displacement amount by which the first target object O1 rotates due to the W rotation moment in a direction parallel to the U axis in the force-detection coordinate system FC. The RRU rotational displacement amount due to the V rotation moment means a rotational displacement amount by which the first target object O1 rotates due to the V rotation moment in a direction parallel to the U axis in the force-detection coordinate system FC. The RRU rotational displacement amount due to the U rotation moment means a rotational displacement amount by which the first target object O1 rotates due to the U rotation moment in a direction parallel to the U axis in the force-detection coordinate system FC.

The TRW rotational displacement amount is a total of a TRW rotational displacement amount due to the X translational force, a TRW rotational displacement amount due to the Y translational force, and a TRW rotational displacement amount due to the Z translational force. The TRW rotational displacement amount due to the X translational force means a rotational displacement amount by which the first target object 01 rotates due to the X translational force in the direction parallel to the W axis in the force-detection coordinate system FC. The TRW rotational displacement amount due to the Y translational force means a rotational displacement amount by which the first target object O1 rotates due to the Y translational force in the direction parallel to the W axis in the force-detection coordinate system FC. The TRW rotational displacement amount due to the Z translational force means a rotational displacement amount by which the first target object O1 rotates due to the Z translational force in the direction parallel to the W axis in the force-detection coordinate system FC.

The TRV rotational displacement amount is a total of a TRV rotational displacement amount due to the X translational force, a TRV rotational displacement amount due to the Y translational force, and a TRV rotational displacement amount due to the Z translational force. The TRV rotational displacement amount due to the X translational force means a rotational displacement amount by which the first target object 01 rotates due to the X translational force in the direction parallel to the V axis in the force-detection coordinate system FC. The TRV rotational displacement amount due to the Y translational force means a rotational displacement amount by which the first target object O1 rotates due to the Y translational force in the direction parallel to the V axis in the force-detection coordinate system FC. The TRV rotational displacement amount due to the Z translational force means a rotational displacement amount by which the first target object O1 rotates due to the Z translational force in the direction parallel to the V axis in the force-detection coordinate system FC.

The TRU rotational displacement amount is a total of a TRU rotational displacement amount due to the X translational force, a TRU rotational displacement amount due to the Y translational force, and a TRU rotational displacement amount due to the Z translational force. The TRU rotational displacement amount due to the X translational force means a rotational displacement amount by which the first target object O1 rotates due to the X translational force in the direction parallel to the U axis in the force-detection coordinate system FC. The TRU rotational displacement amount due to the Y translational force means a rotational displacement amount by which the first target object O1 rotates due to the Y translational force in the direction parallel to the U axis in the force-detection coordinate system FC. The TRU rotational displacement amount due to the Z translational force means a rotational displacement amount by which the first target object O1 rotates due to the Z translational force in the direction parallel to the U axis in the force-detection coordinate system FC.

The robot control device 30 causes the robot 20 to perform displacement actuation of displacing the position and the posture of the control point T1, based on the calculated six translational displacement amounts and six rotational displacement amounts, thereby causing the first target object O1 to be displaced. Note that the robot control device 30 may be configured to calculate the translational displacement amounts and the rotational displacement amounts in accordance with the force control, based on an output of a torque sensor or a current of a servomotor.

The robot control device 30 is capable of displacing the control target (first target object O1 in the example) in a plurality of directions in accordance with the force control, and, in a case where the force detector 21 detects external force, the robot control device performs displacement actuation of displacing the control point T1 in a direction different from a direction of the external force among the plurality of directions. In this manner, the robot control device 30 may cause the robot 20 to highly accurately perform the work of applying the external force in a direction different from a direction parallel to the direction in which the control point T1 is displaced. Hereinafter, the process in which the robot control device 30 performs the displacement actuation in accordance with the force control in the example is described in detail.

Hereinafter, for convenience of description, actuation based on the TTX translational displacement amount, actuation based on the TTY translational displacement amount, and actuation based on the TTZ translational displacement amount of the actuation of the robot 20 will be referred to as first actuation in the description. In other words, the first actuation is actuation of translating the first target object O1 due to some or all of the X translational force, the Y translational force, and the Z translational force (that is, based on the translational force) of the external force detected by the force detector 21.

Hereinafter, actuation based on the TRX translational displacement amount, actuation based on the TRY translational displacement amount, and actuation based on the TRZ translational displacement amount of the actuation of the robot 20 will be referred to as second actuation in the description. In other words, the second actuation is actuation of causing the first target object O1 to rotate due to some or all of the X translational force, the Y translational force, and the Z translational force (that is, based on the translational force) of the external force detected by the force detector 21.

Hereinafter, actuation based on the RTW rotational displacement amount, actuation based on the RTV rotational displacement amount, and actuation based on the RTU rotational displacement amount of the actuation of the robot 20 will be referred to as third actuation in the description. In other words, the third actuation is actuation of translating the first target object O1 due to some or all of the W rotation moment, the V rotation moment, and the U rotation moment (that is, based on the rotation moment) of the external force detected by the force detector 21.

Hereinafter, actuation based on the RRW rotational displacement amount, actuation based on the RRV rotational displacement amount, and actuation based on the RRU rotational displacement amount of the actuation of the robot 20 will be referred to as fourth actuation in the description. In other words, the fourth actuation is actuation of causing the first target object O1 to rotate due to some or all of the W rotation moment, the V rotation moment, and the U rotation moment (that is, based on the rotation moment) of the external force detected by the force detector 21.

### Hardware Configuration of Robot Control Device

Hereinafter, a hardware configuration of the robot control device 30 will be described with reference to FIG. 5. FIG. 5 is a diagram illustrating an example of the hardware configuration of the robot control device 30.

For example, the robot control device 30 includes a central processing unit (CPU) 31, a storage unit 32, an input receiving unit 33, a communication unit 34, and a display unit 35. Such configurational elements are connected via a bus Bus to be capable of communicating with each other. In addition, the robot control device 30 communicates with elements of the robot 20 via the communication unit 34.

The CPU 31 executes various types of programs stored in the storage unit 32.

For example, the storage unit 32 includes a hard disk drive (HDD) or a solid-state drive (SSD), an electrically erasable programmable read-only memory (EEPROM), a read-only memory (ROM), a random-access memory (RAM), or the like. Note that the storage unit 32 may be an external storage device connected through a digital input/output port or the like such as a USB, instead of the internal storage unit installed in the robot control device 30. The storage unit 32 stores various types of information that are processed by the robot control device 30, various types of programs including an actuation program of causing the robot 20 to be actuated, various types of images, or the like.

For example, the input receiving unit 33 is a touch panel that is integrally configured with the display unit 35. Note that the input receiving unit 33 maybe a keyboard, a mouse, a touch panel, or another input device.

For example, the communication unit 34 is configured to include a digital input/output port such as a USB, an Ethernet (registered trademark) port, or the like.

For example, the display unit 35 is a liquid crystal display or an organic electroluminescence (EL) display panel.

Functional Configuration of Robot Control Device

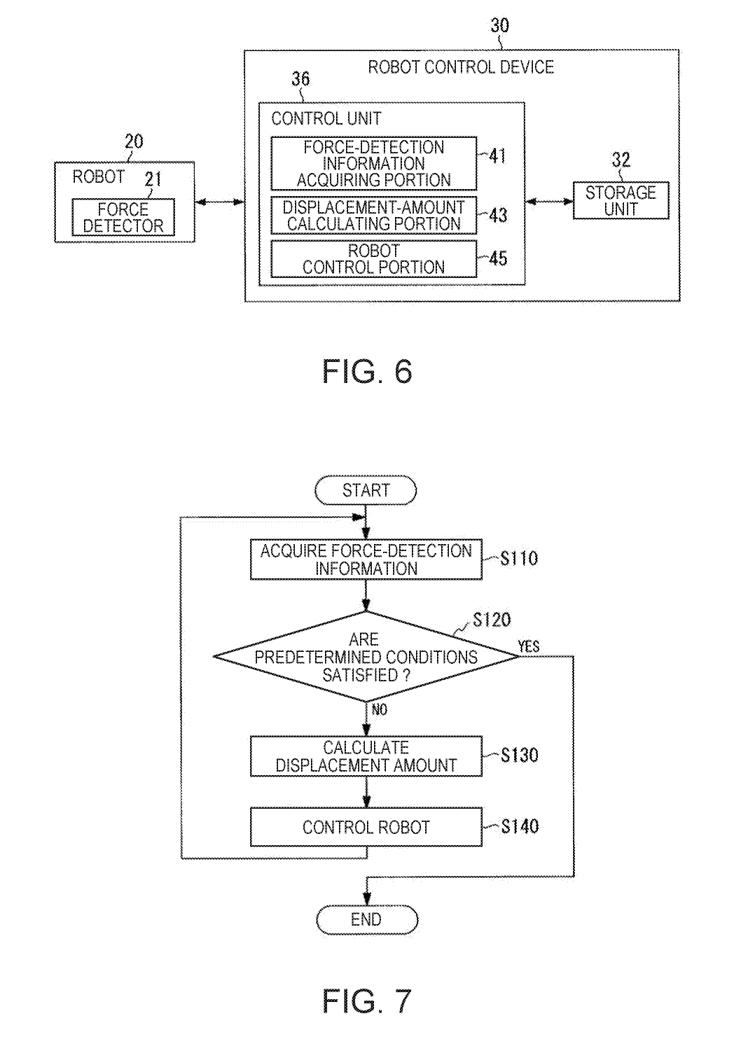

Hereinafter, a functional configuration of the robot control device 30 will be described with reference to FIG. 6. FIG. 6 is a diagram illustrating an example of the functional configuration of the robot control device 30.

The robot control device 30 includes the storage unit 32, and a control unit 36.

The control unit 36 controls the entirety of the robot control device 30. The control unit 36 includes a force-detection information acquiring portion 41, a displacement-amount calculating portion 43, and a robot control portion 45. For example, such functional portions included in the control unit 36 are realized when the CPU 31 executes various types of programs stored in the storage unit 32. In addition, all or some of the functional portions may be hardware functional portions such as large scale integration (LSI), an application specific integrated circuit (ASIC).

The force-detection information acquiring portion 41 acquires the force-detection information from the force detector 21.

The displacement-amount calculating portion 43 calculates, based on the force-detection information acquired by the force-detection information acquiring portion 41, the respective amounts of the TTX translational displacement amount, the TTY translational displacement amount, the TTZ translational displacement amount, the RTX translational displacement amount, the RTY translational displacement amount, the RTZ translational displacement amount, the RRW rotational displacement amount, the RRV rotational displacement amount, the RRU rotational displacement amount, the TRW rotational displacement amount, the TRV rotational displacement amount, and the TRU rotational displacement amount described above.

The robot control portion 45 causes the robot 20 to perform the displacement actuation of displacing the position and the posture of the control point T1, based on respective amounts of the TTX translational displacement amount, the TTY translational displacement amount, the TTZ translational displacement amount, the RTX translational displacement amount, the RTY translational displacement amount, the RTZ translational displacement amount, the RRW rotational displacement amount, the RRV rotational displacement amount, the RRU rotational displacement amount, the TRW rotational displacement amount, the TRV rotational displacement amount, and the TRU rotational displacement amount which are calculated by the displacement-amount calculating portion 43, and the robot control portion causes the robot 20 to perform the predetermined work. In other words, the displacement actuation is displacement actuation depending on the predetermined work.

### Process in Which Robot Control Device Causes Robot to Perform Predetermined Work

Hereinafter, the process in which the robot control device 30 causes the robot 20 to perform the predetermined work will be described with reference to FIG. 7. FIG. 7 is a flowchart illustrating an example of flow of the process in which the robot control device 30 causes the robot 20 to perform predetermined work.

The force-detection information acquiring portion 41 acquires the force-detection information from the force detector 21 (Step S110). Next, the displacement-amount calculating portion 43 determines whether or not the external force indicated by the force-detection information satisfies the predetermined conditions described above, based on the force-detection information acquired in Step S110 (Step S120). In the example, the predetermined conditions are all of the following six conditions of 1) to 6) and the six conditions are satisfied.

1) The X translational force is 0.

2) The Y translational force is 0.

3) The Z translational force is a predetermined threshold value or larger.

4) The W rotation moment is 0.

5) The V rotation moment is 0.

6) The U rotation moment is 0.

For example, in the state of the first target object 01 illustrated in FIG. 3, since all of the six conditions are not satisfied, the displacement-amount calculating portion 43 performs a process in Step S130.

In a case where the displacement-amount calculating portion 43 determines that the external force indicated by the force-detection information satisfies the predetermined conditions in Step S120 (YES in Step S120), the control unit 36 determines that the first target object O1 is fitted into the fitting portion H1, and ends the process. On the other hand, in a case where the displacement-amount calculating portion 43 determines that the external force indicated by the force-detection information does not satisfy the predetermined conditions in Step S120 (NO in Step S120), the displacement-amount calculating portion 43 calculates the translational displacement amount and the rotational displacement amount, based on the force-detection information acquired in Step S110 (Step S130). Here, a process in Step S130 is described.

First, the external force applied to the first target object O1 and a method of calculating a displacement amount depending on the external force under the force control in the example are described.

When external force f(t) is applied to the first target object O1 in a case where a time period t elapses from a time point as a certain reference, a displacement amount s depending on the external force f(t) is calculated under the force control by solving a motion equation expressed by Equation (1).

f(t)=m\ddot{s}+μ\dot{s}+ks (1)

Here, “\dot{}” attached above the displacement amount s in Equation (1) represents differentiation of the displacement amount s by the time period t once. In addition, “\ddot{}” attached above the displacement amount s in Equation (1) represents differentiation of the displacement amount s by the time period t twice. In addition, a coefficient m represents a virtual mass coefficient. In addition, a coefficient μ represents a virtual viscosity coefficient, and a coefficient k represents a virtual elastic coefficient. In other words, the coefficient m, the coefficient μ, and the coefficient k are impedance parameters.

For example, in a case where the external force f(t) is only X translational force fₓ(t), it is possible to calculate the TTX translational displacement amount due to the X translational force, the TTY translational displacement amount due to the X translational force, the TTZ translational displacement amount due to the X translational force, the TRW rotational displacement amount due to the X translational force, the TRV rotational displacement amount due to the X translational force, and the TRU rotational displacement amount due to the X translational force, by solving six motion equations based on the motion equation described above. Equations (2) to (7) are examples of the six motion equations, respectively.

fₓ(t)=mₓₓ\ddot{s}ₓₓ+μₓₓ\dot{s}ₓₓ+kₓₓsₓₓ (2)

fₓ(t)=m_{yx}\ddot{s}_{yx}+μ_{yx}\dot{s}_{yx}+k_{yx}s_{yx} (3)

fₓ(t)=m_{zx}\ddot{s}_{zx}+μ_{zx}\dot{s}_{zx}+k_{zx}s_{zx} (4)

fₓ(t)=m_{wx}\ddot{s}_{wx}+μ_{wx}\dot{s}_{wx}+kᵥₓsᵥₓ (5)

fₓ(t)=mᵥₓ\ddot{s}ᵥₓ+μᵥₓ\dot{s}ᵥₓ+kᵥₓsᵥₓ (6)

fₓ(t)=mᵤₓ\ddot{s}ᵤₓ+μᵤₓ\dot{s}ᵤₓ+kᵤₓsᵤₓ (7)

Here, in Equation (2), a displacement amount sₓₓ is the TTX translational displacement amount due to the X translational force. In addition, “\dot{}” attached above the displacement amount sₓₓ in Equation (2) represents the differentiation of the displacement amount sₓₓ by the time period t once. In addition, “\ddot{}” attached above the displacement amount sₓₓ in Equation (2) represents the differentiation of the displacement amount sₓₓ by the time period t twice. In addition, a coefficient mₓₓ represents a virtual mass coefficient depending on the displacement amount sₓₓ . In addition, a coefficient μₓₓ represents a virtual viscosity coefficient depending on the displacement amount sₓₓ, and a coefficient kₓₓrepresents a virtual elastic coefficient depending on the displacement amount sₓₓ. In other words, the coefficient mₓₓ, the coefficient μₓₓ, and the coefficient kₓₓ are impedance parameters depending on the displacement amount sₓₓ .

Here, in Equation (3), a displacement amount s_{yx} is the TTY translational displacement amount due to the X translational force. In addition, “\dot{}” attached above the displacement amount s_{yx} in Equation (3) represents the differentiation of the displacement amount s_{yx} by the time period t once. In addition, “\ddot{}” attached above the displacement amount s_{yx} in Equation (3) represents the differentiation of the displacement amount s_{yx} by the time period t twice. In addition, a coefficient m_{yx} represents a virtual mass coefficient depending on the displacement amount s_{yx} .

In addition, a coefficient μ_{yx} represents a virtual viscosity coefficient depending on the displacement amount s_{yx}, and a coefficient k_{yx} represents a virtual elastic coefficient depending on the displacement amount s_{yx}. In other words, the coefficient m_{yx}, the coefficient μ_{yx}, and the coefficient k_{yx} are impedance parameters depending on the displacement amount s_{yx} .

In addition, in Equation (4), a displacement amount s_{zx} is the TTZ translational displacement amount due to the X translational force. In addition, “\dot{}” attached above the displacement amount s_{zx} in Equation (4) represents the differentiation of the displacement amount s_{zx} by the time period t once. In addition, “\ddot{}” attached above the displacement amount s_{zx} in Equation (4) represents the differentiation of the displacement amount s_{zx} by the time period t twice. In addition, a coefficient m_{zx} represents a virtual mass coefficient depending on the displacement amount s_{zx}. In addition, a coefficient μ_{zx} represents a virtual viscosity coefficient depending on the displacement amount s_{zx}, and a coefficient k_{zx}represents a virtual elastic coefficient depending on the displacement amount s_{zx}. In other words, the coefficient m_{zx}, the coefficient μ_{zx}, and the coefficient k_{zx} are impedance parameters depending on the displacement amount s_{zx}.

In addition, in Equation (5), a displacement amount s_{wx} is the TRW rotational displacement amount due to the X translational force. In addition, “\dot{}” attached above the displacement amount s_{wx} in Equation (5) represents the differentiation of the displacement amount s_{wx} by the time period t once. In addition, “\ddot{}” attached above the displacement amount s_{wx} in Equation (5) represents the differentiation of the displacement amount s_{wx} by the time period t twice. In addition, a coefficient m_{wx} represents a virtual mass coefficient depending on the displacement amount s_{wx} .

In addition, a coefficient μ_{wx} represents a virtual viscosity coefficient depending on the displacement amount s_{wx}, and a coefficient k_{wx}represents a virtual elastic coefficient depending on the displacement amount s_{wx}. In other words, the coefficient m_{wx}, the coefficient μ_{wx}, and the coefficient k_{wx} are impedance parameters depending on the displacement amount s_{wx} .

In addition, in Equation (6), a displacement amount sᵥₓ is the TRV rotational displacement amount due to the X translational force. In addition, “\dot{}” attached above the displacement amount sᵥₓ in Equation (6) represents the differentiation of the displacement amount sᵥₓ by the time period t once. In addition, “\ddot{}” attached above the displacement amount sᵥₓ in Equation (6) represents the differentiation of the displacement amount sᵥₓ by the time period t twice. In addition, a coefficient mᵥₓ represents a virtual mass coefficient depending on the displacement amount sᵥₓ. In addition, a coefficient μᵥₓ represents a virtual viscosity coefficient depending on the displacement amount sᵥₓ, and a coefficient kᵥₓrepresents a virtual elastic coefficient depending on the displacement amount sᵥₓ. In other words, the coefficient mᵥₓ, the coefficient μᵥₓ, and the coefficient kᵥₓ are impedance parameters depending on the displacement amount sᵥₓ.

In addition, in Equation (7), a displacement amount sᵤₓ is the TRU rotational displacement amount due to the X translational force. In addition, “\dot{}” attached above the displacement amount sᵤₓ in Equation (7) represents the differentiation of the displacement amount sᵤₓ by the time period t once. In addition, “\dot{}” attached above the displacement amount sᵤₓ in Equation (7) represents the differentiation of the displacement amount sᵤₓ by the time period t twice. In addition, a coefficient mᵤₓ represents a virtual mass coefficient depending on the displacement amount sᵤₓ. In addition, a coefficient μᵤₓ represents a virtual viscosity coefficient depending on the displacement amount sᵤₓ, and a coefficient kᵤₓ represents a virtual elastic coefficient depending on the displacement amount sᵤₓ. In other words, the coefficient mᵤₓ, the coefficient μᵤₓ, and the coefficient kᵤₓ are impedance parameters depending on the displacement amount sᵤₓ.

By solving the six motion equations of Equations (2) to (7), the robot control device 30 can calculate the translational displacement amounts and the rotational displacement amounts due to the X translational force fₓ(t) (that is, the TTX translational displacement amount due to the X translational force fₓ(t), the TTY translational displacement amount due to the X translational force fₓ(t), the TTZ translational displacement amount due to the X translational force fₓ(t), the TRW rotational displacement amount due to the X translational force fₓ(t), the TRV rotational displacement amount due to the X translational force fₓ(t), and the TRU rotational displacement amount due to the X translational force fₓ(t)).

Note that, under the force control in the related art, the coefficient mₓₓ, the coefficient μₓₓ, and the coefficient kₓₓ are not 0, but are respective finite values, the coefficient m_{yx}, the coefficient μ_{yx}, the coefficient k_{yx}, the coefficient m_{zx}, the coefficient μ_{zx}, the coefficient k_{zx}, the coefficient m_{wx}, the coefficient μ_{wx}, the coefficient k_{wx}, the coefficient m_{yx}, the coefficient μ_{yx}, the coefficient kᵥₓ, the coefficient mᵤₓ, the coefficient μᵤₓ, and the coefficient kᵤₓ are all 0. Note that, under the force control in the example, some or all of the coefficient m_{yx}, the coefficient μ_{yx}, the coefficient k_{yx}, the coefficient m_{zx}, the coefficient μ_{zx}, the coefficient k_{zx}, the coefficient m_{wx}, the coefficient μ_{wx}, the coefficient k_{wx}, the coefficient mᵥₓ, the coefficient μᵥₓ, the coefficient kᵥₓ, the coefficient mᵤₓ, the coefficient μᵤₓ, and the coefficient kᵤₓ are not 0, but are finite values. Therefore, the robot control device 30 can displace the control point T1 in a direction different from a direction of the external force fₓ(t).

In addition, similar to the translational displacement amounts and the rotational displacement amounts due to the X translational force fₓ(t), the translational displacement amounts and the rotational displacement amounts due to the Y translational force, the Z translational force, the W rotation moment, the V rotation moment, and the U rotation moment can be calculated by solving the motion equations based on Equation (1), and thus the description thereof is omitted.

Here, the motion equations (that is, Equations (2) to (7) in the example) derived from Equation (1) can be solved by an algorithm such as Newton's method or the Runge-Kutta methods. However, such techniques are not suitable for hardware implementation and it is also difficult to determine stability of the techniques. In addition, it is difficult for the techniques to respond to switching of responsiveness. For this reason, under the force control, a method of solving the motion equation by using a digital filter is used in some cases. Hereinafter, as an example, a case where the displacement-amount calculating portion 43 solves the motion equation by using the method will be described.

Equation (1), as the motion equation, is a linear ordinary differential equation. Therefore, when it is possible to obtain impulse response as a solution to an impulse input, the displacement-amount calculating portion 43 can derive a solution of the motion equation with respect to any external force term by convolution of the impulse response with the external force term.

Here, it is possible to derive the solution of Equation (1) as the motion equation from a filter in which the force-detection information acquired by the force-detection information acquiring portion 41 is an input and a solution with respect to the input is an output. In this case, the motion equation is considered a two-pole analog filter. In other words, it is possible to derive the solution of the motion equation as an output of a corresponding analog filter. In this manner, the analog filter is converted into the digital filter, and thereby the displacement-amount calculating portion 43 can solve the motion equation by using the digital filter.

A method of converting the analog filter into the digital filter may be a known method or may be a method developed from the known method. Here, as an example, a case of using an impulse•invariance method as the method of converting into the digital filter is described. The impulse•invariance method is a method of obtaining a digital filter that applies the same impulse response as a value obtained by sampling the impulse response of the analog filter in discrete time T. The impulse•invariance method is the known method, and thus the description thereof is omitted.

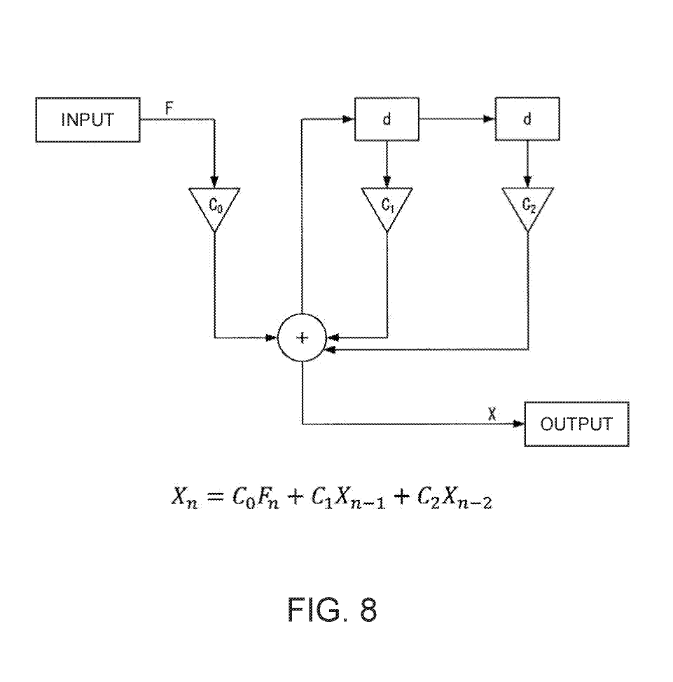

In a case where the analog filter is converted into the digital filter by the impulse•invariance method, Equation (1), as the motion equation, is converted into the two-pole digital filter illustrated in FIG. 8. FIG. 8 is a diagram illustrating an example of the digital filter converted from the motion equation expressed by Equation (1) by the impulse•invariance method. d in FIG. 8 represents a delay by sampling once, and C₀, C₁, and C₂ are respective coefficients of the digital filter. A process through the digital filter is easily performed by hardware implementation and it is easy to determine stability of the process. In addition, switching of the coefficients of the digital filter enables the displacement-amount calculating portion 43 to switch behavior (soft movement, hard movement, or the like) of the first target object O1 (that is, the control point T1) in accordance with the force control. In addition, switching of the coefficients enables the displacement-amount calculating portion 43 to switch filter drive frequencies and to switch responsiveness of the solution of the motion equation. Here, the equation illustrated in FIG. 8 is a motion equation used in a case where the motion equation is represented by the digital filter. A time period n in the motion equation represents a variable indicating that a time period of n times the discrete time T elapses from the time point as a certain reference. Note that the time period n is a positive or negative integer including 0. In addition, external force Fn in the motion equation is an input to the digital filter illustrated in FIG. 8 and represents external force detected by the force detector 21 in the time period n. In addition, a displacement amount Xn in the motion equation represents a displacement amount by which the first target object O1 is displaced in the time period n.

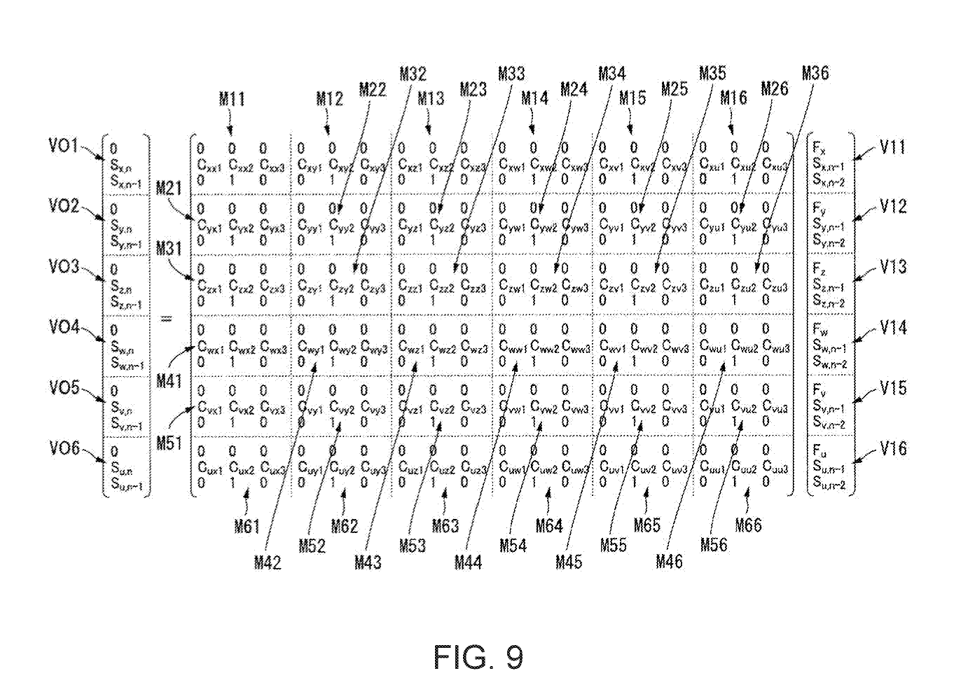

By converting the motion equation expressed by Equation (1) into the digital filter, the motion equation, by which the respective amounts of the TTX translational displacement amount, the TTY translational displacement amount, the TTZ translational displacement amount, the RTX translational displacement amount, the RTY translational displacement amount, the RTZ translational displacement amount, the RRW rotational displacement amount, the RRV rotational displacement amount, the RRU rotational displacement amount, the TRW rotational displacement amount, the TRV rotational displacement amount, and the TRU rotational displacement amount described above are calculated, can be expressed as Equation (8) illustrated in FIG. 9 by using products of matrices and vectors. FIG. 9 is a diagram illustrating an example of Equation (8). Specifically, FIG. 9 is a diagram illustrating, by converting the motion equation expressed by Equation (1) into the digital filter, an example of the motion equation, by which the respective amounts of the TTX translational displacement amount, the TTY translational displacement amount, the TTZ translational displacement amount, the RTX translational displacement amount, the RTY translational displacement amount, the RTZ translational displacement amount, the RRW rotational displacement amount, the RRV rotational displacement amount, the RRU rotational displacement amount, the TRW rotational displacement amount, the TRV rotational displacement amount, and the TRU rotational displacement amount described above are calculated.

Here, in Equation (8) illustrated in FIG. 9, similar to the time period n illustrated in FIG. 8, a time period n is a variable indicating that a time period of n times the discrete time T elapses from the time point as a certain reference. Note that the time period n is a positive or negative integer including 0. X translational force Fₓ represents the X translational force applied to the first target object O1 in the time period n. Y translational force F_{y} represents the Y translational force applied to the first target object O1 in the time period n. Z translational force F_{z} represents the Z translational force applied to the first target object O1 in the time period n. W rotation moment F_{w} represents the W rotation moment applied to the first target object O1 in the time period n. V rotation moment Fᵥ represents the V rotation moment applied to the first target object O1 in the time period n. U rotation moment Fᵤrepresents the U rotation moment applied to the first target object O1 in the time period n.

In addition, in Equation (8), a displacement amount S_{x,n} represents the X translational displacement amount by which the first target object O1 is translated in the time period n in the direction parallel to the X axis in the force-detection coordinate system FC. In other words, the displacement amount S_{x,n} is a total of the TTX translational displacement amount due to the X translational force, the TTX translational displacement amount due to the Y translational force, the TTX translational displacement amount due to the Z translational force, the RTX translational displacement amount due to the W rotation moment, the RTX translational displacement amount due to the V rotation moment, and the RTX translational displacement amount due to the U rotation moment. In addition, a displacement amount S_{x,n-1} represents an X translational displacement amount in a time period n-1. In addition, a displacement amount S_{x,n-2} represents an X translational displacement amount in a time period n−2.

In addition, in Equation (8), a displacement amount S_{y,n} represents the Y translational displacement amount by which the first target object O1 is translated in the time period n in the direction parallel to the Y axis in the force-detection coordinate system FC. In addition, the displacement amount S_{y,n} is a total of the TTY translational displacement amount due to the X translational force, the TTY translational displacement amount due to the Y translational force, the TTY translational displacement amount due to the Z translational force, the RTY translational displacement amount due to the W rotation moment, the RTY translational displacement amount due to the V rotation moment, and the RTY translational displacement amount due to the U rotation moment. In addition, a displacement amount S_{y,n-1} represents a Y translational displacement amount in a time period n-1. In addition, a displacement amount S_{y,n-2} represents a Y translational displacement amount in a time period n−2.

In addition, in Equation (8), a displacement amount S_{z,n} represents the Z translational displacement amount by which the first target object O1 is translated in the time period n in the direction parallel to the Z axis in the force-detection coordinate system FC. In addition, the displacement amount S_{z,n} is a total of the TTZ translational displacement amount due to the X translational force, the TTZ translational displacement amount due to the Y translational force, the TTZ translational displacement amount due to the Z translational force, the RTZ translational displacement amount due to the W rotation moment, the RTZ translational displacement amount due to the V rotation moment, and the RTZ translational displacement amount due to the U rotation moment. In addition, a displacement amount S_{z,n-1} represents a Z translational displacement amount in a time period n-1. In addition, a displacement amount S_{z,n-2} represents a Z translational displacement amount in a time period n−2.

In addition, in Equation (8), a displacement amount S_{w,n} represents the W rotational displacement amount by which the first target object O1 is rotated in the time period n in the direction parallel to the W axis in the force-detection coordinate system FC. In addition, the displacement amount S_{w,n} is a total of the TRW rotational displacement amount due to the X translational force, the TRW rotational displacement amount due to the Y translational force, the TRW rotational displacement amount due to the Z translational force, the RRW rotational displacement amount due to the W rotation moment, the RRW rotational displacement amount due to the V rotation moment, and the RRW rotational displacement amount due to the U rotation moment. In addition, a displacement amount S_{w,n-1} represents a W rotational displacement amount in a time period n−1. In addition, a displacement amount S_{w,n-2} represents a W rotational displacement amount in a time period n−2.

In addition, in Equation (8), a displacement amount S_{v,n} represents the V rotational displacement amount by which the first target object O1 is rotated in the time period n in the direction parallel to the V axis in the force-detection coordinate system FC. In addition, the displacement amount S_{v,n} is a total of the TRV rotational displacement amount due to the X translational force, the TRV rotational displacement amount due to the Y translational force, the TRV rotational displacement amount due to the Z translational force, the RRV rotational displacement amount due to the W rotation moment, the RRV rotational displacement amount due to the V rotation moment, and the RRV rotational displacement amount due to the U rotation moment. In addition, a displacement amount S_{v,n-1} represents a V rotational displacement amount in a time period n−1. In addition, a displacement amount S_{v,n-2} represents a V rotational displacement amount in a time period n−2.

In addition, in Equation (8), a displacement amount S_{u,n} represents the U rotational displacement amount by which the first target object O1 is rotated in the time period n in the direction parallel to the U axis in the force-detection coordinate system FC. In addition, the displacement amount S_{u,n} is a total of the TRU rotational displacement amount due to the X translational force, the TRU rotational displacement amount due to the Y translational force, the TRU rotational displacement amount due to the Z translational force, the RRU rotational displacement amount due to the W rotation moment, the RRU rotational displacement amount due to the V rotation moment, and the RRU rotational displacement amount due to the U rotation moment. In addition, a displacement amount S_{u,n-1} represents a U rotational displacement amount in a time period n−1. In addition, a displacement amount S_{u,n-2} represents a U rotational displacement amount in a time period n−2.

In addition, in Equation (8), a coefficient C_{xx1,} a coefficient Cₓₓ₂, a coefficient Cₓₓ₃, a coefficient C_{xy1}, a coefficient C_{xy2}, a coefficient C_{xy3}, a coefficient Cₓₓ₁, a coefficient C_{xz2}, a coefficient C_{xz3}, a coefficient C_{xw1}, a coefficient C_{xw2}, a coefficient C_{xw3}, a coefficient Cₓᵥ₁, a coefficient Cₓᵥ₂, a coefficient Cₓᵥ₃, a coefficient Cₓᵤ₁, a coefficient Cₓᵤ₂, a coefficient C_{xu3,} a coefficient C_{yx1}, a coefficient C_{yx2}, a coefficient C_{yx3}, a coefficient C_{yy1}, a coefficient C_{yy2}, a coefficient C_{yy3}, a coefficient C_{yz1}, a coefficient C_{yz2}, a coefficient C_{yz3}, a coefficient C_{yw1}, a coefficient C_{yw2}, a coefficient C_{yw3}, a coefficient C_{yv1}, a coefficient C_{yv2}, a coefficient C_{yv3}, a coefficient C_{yu1}, a coefficient C_{yu2}, a coefficient C_{yu3}, a coefficient C_{zx1}, a coefficient C_{zx2}, a coefficient C_{zx3}, a coefficient C_{zy1}, a coefficient C_{zy2}, a coefficient C_{zy3}, a coefficient C_{zz1}, a coefficient C_{zz2}, a coefficient C_{zz3}, a coefficient C_{zw1}, a coefficient C_{zw2}, a coefficient C_{zw3}, a coefficient C_{zv1}, a coefficient C_{zv2}, a coefficient C_{zv3}, a coefficient C_{zu1}, a coefficient C_{zu2}, a coefficient C_{zu3}, a coefficient C_{wx1}, a coefficient C_{wx2}, a coefficient C_{wx3,} a coefficient C_{wy1}, a coefficient C_{wy2}, a coefficient C_{wy3}, a coefficient C_{wz1}, a coefficient C_{wz2}, a coefficient C_{wz3}, a coefficient C_{ww1}, a coefficient C_{ww2}, a coefficient C_{ww3}, a coefficient C_{wv1}, a coefficient C_{wv2}, a coefficient C_{wv3}, a coefficient C_{wu1}, a coefficient C_{wu2}, a coefficient C_{wu3}, a coefficient Cᵥₓ₁, a coefficient Cᵥₓ₂, a coefficient Cᵥₓ₃, a coefficient C_{vy1}, a coefficient C_{vy2}, a coefficient C_{vy3}, a coefficient C_{vz1}, a coefficient C_{vz2}, a coefficient C_{vz3}, a coefficient C_{vw1}, a coefficient C_{vw2}, a coefficient C_{vw3}, a coefficient Cᵥᵥ₁, a coefficient Cᵥᵥ₂, a coefficient Cᵥᵥ₃, a coefficient Cᵥᵤ₁, a coefficient Cᵥᵤ₂, a coefficient Cᵥᵤ₃, a coefficient Cᵤₓ₁, a coefficient Cᵤₓ₂, a coefficient Cᵤₓ₃, a coefficient C_{uy1}, a coefficient C_{uy2}, a coefficient C_{uy3}, a coefficient C_{uz1}, a coefficient C_{uz2}, a coefficient C_{uz3}, a coefficient C_{uw1}, a coefficient C_{uw2}, a coefficient C_{uw3}, a coefficient Cᵤᵥ₁, a coefficient Cᵤᵥ₂, a coefficient Cᵤᵥ₃, a coefficient Cᵤᵤ₁, a coefficient Cᵤᵤ₂, and a coefficient Cᵤᵤ₃ are all the impedance parameters after the conversion into the digital filter. Hereinafter, for convenience of description, the coefficients are collectively referred to as coefficients C as long as there is no need to distinguish the coefficients.

Here, a matrix illustrated in equation (8) is configured of 36 submatrices (3×3 matrices) in dotted lines as illustrated in FIG. 9. In addition, vectors on the right side in Equation (8) are configured of six three-component vectors in dotted lines as illustrated in FIG. 9. In addition, vectors on the left side in Equation (8) are configured of six three-component vectors in dotted lines as illustrated in FIG. 9.

Hence, the TTX translational displacement amount due to the X translational force is calculated as the second component of a vector obtained by multiplying a submatrix M11 by a three-component vector V11. In addition, the TTX translational displacement amount due to the Y translational force is calculated as the second component of a vector obtained by multiplying a submatrix M12 by a three-component vector V12. In addition, the TTX translational displacement amount due to the Z translational force is calculated as the second component of a vector obtained by multiplying a submatrix M13 by a three-component vector V13. In addition, the RTX translational displacement amount due to the W rotation moment is calculated as the second component of a vector obtained by multiplying a submatrix M14 by a three-component vector V14. In addition, the RTX translational displacement amount due to the V rotation moment is calculated as the second component of a vector obtained by multiplying a submatrix M15 by a three-component vector V15. In addition, the RTX translational displacement amount due to the U rotation moment is calculated as the second component of a vector obtained by multiplying a submatrix M16 by a three-component vector V16. A total of the second components is the X translational displacement amount described above, that is, the displacement amount S_{x,n} of the second component of a three-component vector V01.

In addition, the TTY translational displacement amount due to the X translational force is calculated as the second component of a vector obtained by multiplying a submatrix M21 by the three-component vector V11. In addition, the TTY translational displacement amount due to the Y translational force is calculated as the second component of a vector obtained by multiplying a submatrix M22 by the three-component vector V12. In addition, the TTY translational displacement amount due to the Z translational force is calculated as the second component of a vector obtained by multiplying a submatrix M23 by the three-component vector V13. In addition, the RTY translational displacement amount due to the W rotation moment is calculated as the second component of a vector obtained by multiplying a submatrix M24 by the three-component vector V14. In addition, the RTY translational displacement amount due to the V rotation moment is calculated as the second component of a vector obtained by multiplying a submatrix M25 by the three-component vector V15. In addition, the RTY translational displacement amount due to the U rotation moment is calculated as the second component of a vector obtained by multiplying a submatrix M26 by the three-component vector V16. A total of the second components is the Y translational displacement amount described above, that is, the displacement amount S_{y,n} of the second component of a three-component vector VO2.

In addition, the TTZ translational displacement amount due to the X translational force is calculated as the second component of a vector obtained by multiplying a submatrix M31 by the three-component vector V11. In addition, the TTZ translational displacement amount due to the Y translational force is calculated as the second component of a vector obtained by multiplying a submatrix M32 by the three-component vector V12. In addition, the TTZ translational displacement amount due to the Z translational force is calculated as the second component of a vector obtained by multiplying a submatrix M33 by the three-component vector V13. In addition, the RTZ translational displacement amount due to the W rotation moment is calculated as the second component of a vector obtained by multiplying a submatrix M34 by the three-component vector V14. In addition, the RTZ translational displacement amount due to the V rotation moment is calculated as the second component of a vector obtained by multiplying a submatrix M35 by the three-component vector V15. In addition, the RTZ translational displacement amount due to the U rotation moment is calculated as the second component of a vector obtained by multiplying a submatrix M36 by the three-component vector V16. A total of the second components is the Z translational displacement amount described above, that is, the displacement amount S_{z,n} of the second component of a three-component vector V03.

In addition, the TRW rotational displacement amount due to the X translational force is calculated as the second component of a vector obtained by multiplying a submatrix M41 by the three-component vector V11. In addition, the TRW rotational displacement amount due to the Y translational force is calculated as the second component of a vector obtained by multiplying a submatrix M42 by the three-component vector V12. In addition, the TRW rotational displacement amount due to the Z translational force is calculated as the second component of a vector obtained by multiplying a submatrix M43 by the three-component vector V13. In addition, the RRW rotational displacement amount due to the W rotation moment is calculated as the second component of a vector obtained by multiplying a submatrix M44 by the three-component vector V14. In addition, the RRW rotational displacement amount due to the V rotation moment is calculated as the second component of a vector obtained by multiplying a submatrix M45 by the three-component vector V15. In addition, the RRW rotational displacement amount due to the U rotation moment is calculated as the second component of a vector obtained by multiplying a submatrix M46 by the three-component vector V16. A total of the second components is the W translational displacement amount described above, that is, the displacement amount S_{w,n} of the second component of a three-component vector VO4.

In addition, the TRV rotational displacement amount due to the X translational force is calculated as the second component of a vector obtained by multiplying a submatrix M51 by the three-component vector V11. In addition, the TRV rotational displacement amount due to the Y translational force is calculated as the second component of a vector obtained by multiplying a submatrix M52 by the three-component vector V12. In addition, the TRV rotational displacement amount due to the Z translational force is calculated as the second component of a vector obtained by multiplying a submatrix M53 by the three-component vector V13. In addition, the RRV rotational displacement amount due to the W rotation moment is calculated as the second component of a vector obtained by multiplying a submatrix M54 by the three-component vector V14. In addition, the RRV rotational displacement amount due to the V rotation moment is calculated as the second component of a vector obtained by multiplying a submatrix M55 by the three-component vector V15. In addition, the RRV rotational displacement amount due to the U rotation moment is calculated as the second component of a vector obtained by multiplying a submatrix M56 by the three-component vector V16. A total of the second components is the V rotational displacement amount described above, that is, the displacement amount S_{v,n} of the second component of a three-component vector VO5.

In addition, the TRU rotational displacement amount due to the X translational force is calculated as the second component of a vector obtained by multiplying a submatrix M61 by the three-component vector V11. In addition, the TRU rotational displacement amount due to the Y translational force is calculated as the second component of a vector obtained by multiplying a submatrix M62 by the three-component vector V12. In addition, the TRU rotational displacement amount due to the Z translational force is calculated as the second component of a vector obtained by multiplying a submatrix M63 by the three-component vector V13. In addition, the RRU rotational displacement amount due to the W rotation moment is calculated as the second component of a vector obtained by multiplying a submatrix M64 by the three-component vector V14. In addition, the RRU rotational displacement amount due to the V rotation moment is calculated as the second component of a vector obtained by multiplying a submatrix M65 by the three-component vector V15. In addition, the RRU rotational displacement amount due to the U rotation moment is calculated as the second component of a vector obtained by multiplying a submatrix M66 by the three-component vector V16. A total of the second components is the U rotational displacement amount described above, that is, the displacement amount S_{u,n} of the second component of a three-component vector VO6.

The displacement-amount calculating portion 43 calculates the amounts of the X translational displacement amount, the Y translational displacement amount, the Z translational displacement amount, the W rotational displacement amount, the V rotational displacement amount, and the U rotational displacement amount, based on Equation (8) illustrated in FIG. 9 and the respective values of the coefficients C. The amounts of the X translational displacement amount, the Y translational displacement amount, the Z translational displacement amount, the W rotational displacement amount, the V rotational displacement amount, and the U rotational displacement amount are values depending on the respective values of the coefficients C. For example, in a case where the force detector 21 detects only the X translational force, the displacement-amount calculating portion 43 can calculate some or all of the X translational displacement amount, the Y translational displacement amount, the Z translational displacement amount, the W rotational displacement amount, the V rotational displacement amount, and the U rotational displacement amount, as finite values without 0 depending on the respective values of the coefficients C. In other words, the displacement-amount calculating portion 43 can calculate some or all of the X translational displacement amount, the Y translational displacement amount, the Z translational displacement amount, the W rotational displacement amount, the V rotational displacement amount, and the U rotational displacement amount, as 0depending on the respective values of the coefficients C.

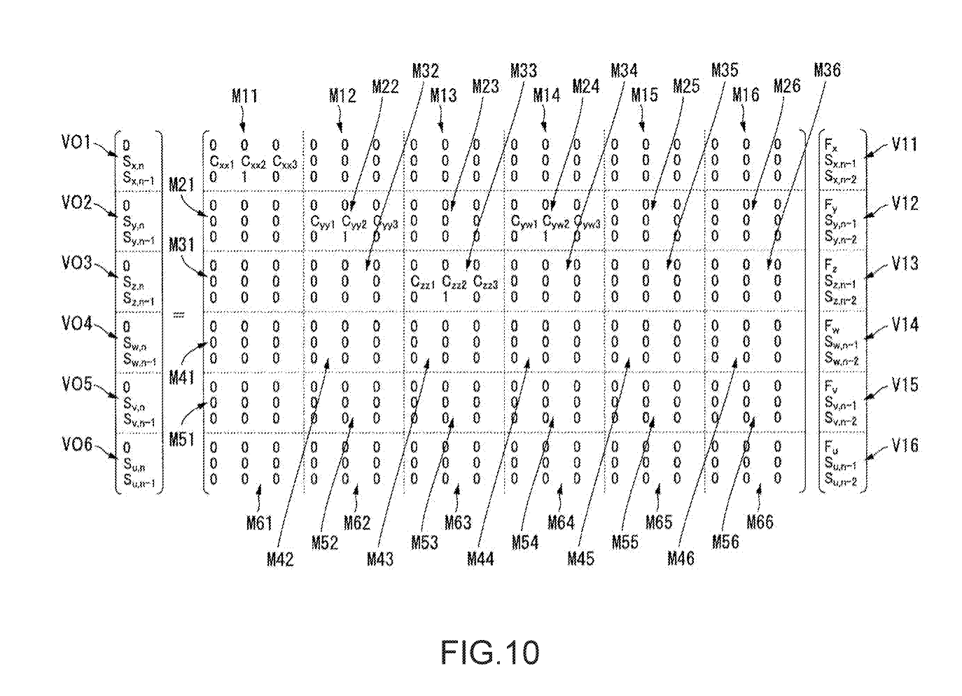

Hereinafter, as an example, a case where the respective coefficients C are determined as in Equation (9) illustrated in FIG. 10 is described. FIG. 10 is a diagram illustrating Equation (9). The coefficients C of the coefficient Cₓₓ₁, the coefficient Cₓₓ₂, the coefficient Cₓₓ₃, the coefficient C_{yy1}, the coefficient C_{yy2}, the coefficient C_{yy3}, the coefficient C_{zz1}, the coefficient C_{zz2}, the coefficient C_{zz3}, the coefficient C_{wy1}, the coefficient C_{wy2}, and the coefficient C_{wy3} included in a matrix expressed in Equation (9) are all finite values without 0, and coefficients other than those included in the coefficients C are all 0. The respective coefficients C are determined, and thereby it is possible for the robot control device 30 to highly accurately perform the work of applying the external force in a direction different from a direction parallel to the direction in which the first target object O1 is displaced. The work is the predetermined work in the example as described above.

After the process in Step S130 is performed, the robot control portion 45 calculates a position and a posture of the control point T1 which are measured after a current position and a current posture of the control point T1 are displaced by respective amounts of the X translational displacement amount, the Y translational displacement amount, the Z translational displacement amount, the W rotational displacement amount, the V rotational displacement amount, and the U rotational displacement amount, based on the respective amounts of the X translational displacement amount, the Y translational displacement amount, the Z translational displacement amount, the W rotational displacement amount, the V rotational displacement amount, and the U rotational displacement amount which are calculated in Step S130, and the current position and posture of the control point T1 . The robot control portion 45 designates information indicating the calculated position as the control-point positional information, and designates information indicating the calculated posture as the control-point posture information. In this manner, the robot control portion 45 causes the robot 20 to be actuated such that the position and the posture of the control point T1 are coincident with the target position and the target posture (Step S140). The force-detection information acquiring portion 41 transitions to Step S110, and reacquires the force-detection information from the force detector 21.

As described above, the processes in Steps S110 to S140 iterate, and thereby the robot control device 30 causes the robot 20 to perform the predetermined work. In other words, in the example, the robot control device 30 causes the robot 20 to be actuated and causes the robot 20 to perform, as the predetermined work, the work of fitting the first target object O1 into the second target object O2. Here, with the chamferless fitting work described in FIGS. 2 to 4 as an example, the actuation of the robot 20 which is performed through iteration of the processes in Steps 5110 to 5140 is described.

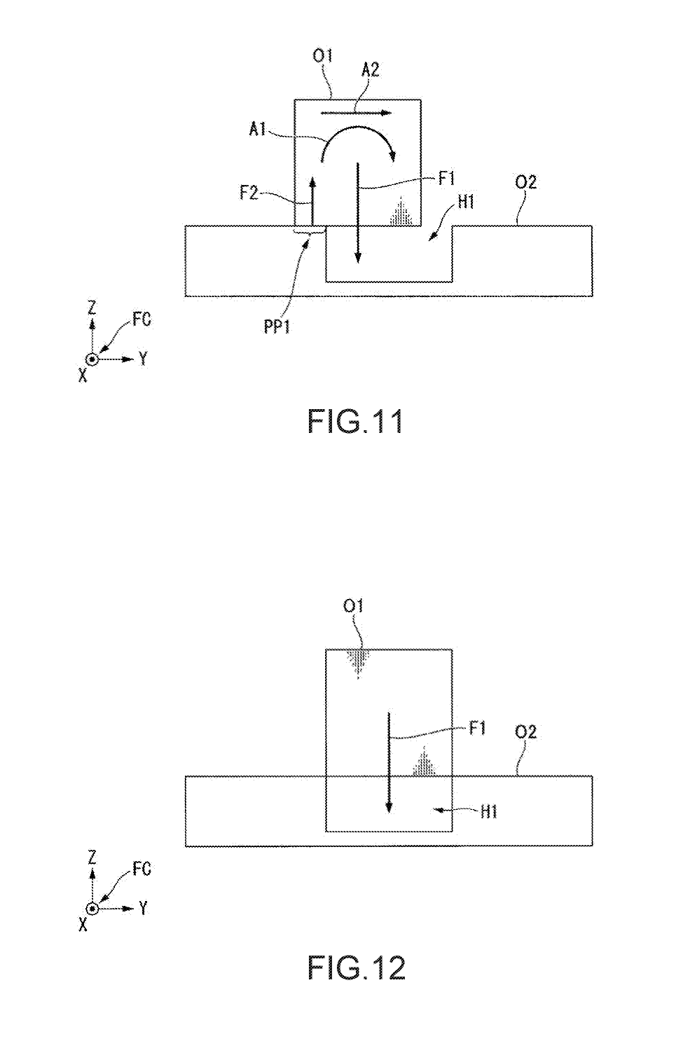

The robot control portion 45 causes the robot 20 to be actuated such that the force Fl is applied to the first target object O1 illustrated in FIG. 2 in the negative direction of the Z axis in the force-detection coordinate system FC. In this case, the first target object O1 is displaced in the direction of the force Fl. Similar to the first target object O1 illustrated in FIG. 3, the region PP1 of the first target object O1 displaced in the direction comes into contact with the second target object O2 at the position different from the fitting portion H1 of the positions thereof. In such a case where the first target object O1 comes into contact with the second target object O2, the force F2 is applied to the region PP1 from the second target object O2 in the positive direction of the Z axis as illustrated in FIG. 11. As a result, rotation moment is applied to the first target object O1 from the second target object O2 in the direction Al represented by the arrow in FIG. 3. FIG. 11 is a diagram illustrating an example of a state in which the force F2 is applied from the second target object O2 to the region PP1 in the positive direction of the Z axis in the force-detection coordinate system FC, in the force control in the example.

In this case, under the force control in the example, the robot control portion 45 translates the first target object O1 in a direction A2 represented by an arrow illustrated in FIG. 11. This is a result obtained when the robot control portion 45 causes the robot 20 to perform the displacement actuation of displacing the position and the posture of the control point T1, based on the respective amounts of the X translational displacement amount, the Y translational displacement amount, the Z translational displacement amount, the W rotational displacement amount, the V rotational displacement amount, and the U rotational displacement amount which are calculated, based on Equation (9) illustrated in FIG. 10.

Specifically, in the state illustrated in FIG. 11, in Step S130, the displacement-amount calculating portion 43 substitutes Z translational force F_{z} in Equation (9) illustrated in FIG. 10 with a total force of the force F1 and the force F2 illustrated in FIG. 11, and substitutes W rotation moment F_{w} in Equation (9) illustrated in FIG. 10 with the W rotation moment by which the first target object O1 rotates due to the force F2 in the direction Al illustrated in FIG. 11. Here, as described above, the respective coefficients C are determined as in Equation (9) illustrated in FIG. 10. Therefore, the displacement-amount calculating portion 43 calculates, as 0, the amounts of the X translational displacement amount S_{x,n}, the W rotational displacement amount S_{w,n}, the V rotational displacement amount S_{v,n}, and the U rotational displacement amount S_{v,n}. The displacement-amount calculating portion 43 calculates, as finite values without 0, the amounts of the Y translational displacement amount S_{y,n} and the Z translational displacement amount S_{z,n}. The reason that the Z translational displacement amount S_{z,n} is calculated as the finite value is that the three-component vector V13 including the Z translational force F_{z} of the submatrices that configure the matrix illustrated in Equation (9) is multiplied by the submatrix M33 containing the coefficients C (in the example, the coefficients of the coefficient C_{zz1}, the coefficient C_{zz2}, and the coefficient C_{zz3}) which are not 0. In addition, the reason that the Y translational displacement amount S_{y,n} is calculated as the finite value is that the three-component vector V14 including the W rotation moment F_{w} is multiplied by the submatrix M24 containing the coefficients C (in the example, the coefficients of the coefficient C_{yw1}, the coefficient C_{yw2}, and the coefficient C_{yw3}) which are not 0.

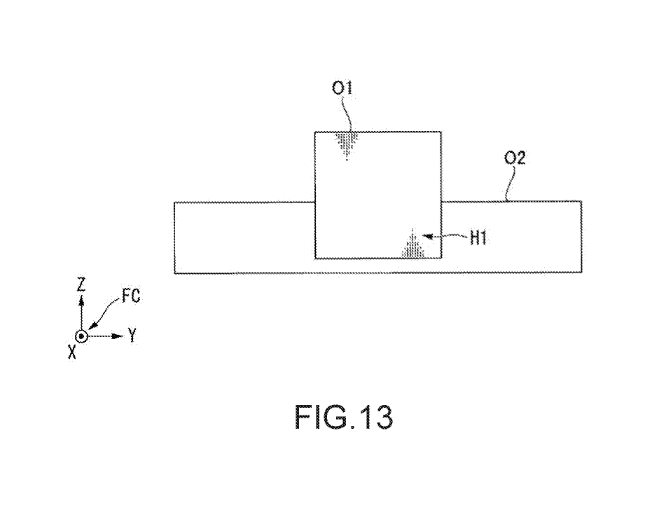

The second component of the vector obtained by multiplying the submatrix M33 by the three-component vector V13 is the TTZ translational displacement amount due to the Z translational force. In addition, the second component of the vector obtained by multiplying the submatrix M24 by the three-component vector V14 is the RTY translational displacement amount due to the W rotation moment. In other words, the robot control device 30 causes the robot 20 to perform, as the displacement actuation, actuation on the basis of the first actuation based on the TTZ translational displacement amount and the third actuation based on the RTY translational displacement amount, such that translation in the direction A2 illustrated in FIG. 11 is performed and the state illustrated in FIG. 12 is realized as a relative positional relationship between the first target object O1 and the second target object O2 illustrated in FIG. 11 is maintained (as the contact of the first target object O1 with the second target object O2 is maintained while the posture of the first target object O1 is maintained). FIG. 12 is a diagram illustrating an example of states of the first target object O1 and the second target object O2 after the first target object O1 illustrated in FIG. 11 is translated in the direction A2. The state of the first target object O1 illustrated in FIG. 12 is the state of being fitted into the fitting portion H1 by the translation in the negative direction of the Z axis in the force-detection coordinate system FC. In this state, the robot control portion 45 displaces the first target object O1 such that the predetermined conditions are satisfied through the force control in the example. In other words, the robot control portion 45 translates the first target object O1 in the negative direction and causes the first target object O1 to be fitted into the fitting portion H1 as illustrated in FIG. 13. FIG. 13 is a diagram illustrating an example of the state in which the first target object O1 is fitted into the fitting portion Hl.

As described above, in the case where the force detector 21 detects the external force, based on Equation (9) illustrated in FIG. 10, the robot control device 30 causes the robot 20 to perform the displacement actuation of displacing the first target object O1 in the direction different from the direction of the external force among the plurality of directions. In other words, the robot control device 30 causes the robot to perform the displacement actuation based on the result obtained from the matrix operation of the digital filter described above. In this manner, the robot control device 30 can highly accurately perform the work of applying the external force in the direction different from the direction parallel to the direction in which the first target object O1 is displaced.

Here, in the work (that is, the chamferless fitting work of the first target object O1 into the second target object O2) described above, the robot control device 30 causes the robot 20 to perform, as the displacement actuation, the actuation based on the first actuation and the third actuation; however, this is only an example. For example, the robot control device 30 causes, depending on the work, the robot 20 to perform, as the displacement actuation, the actuation based on some or all of the first actuation, the second actuation, the third actuation, and the fourth actuation. In other words, the displacement actuation that the robot control device 30 causes the robot 20 to perform, includes at least one of the first actuation, the second actuation, the third actuation, and the fourth actuation. In this manner, the robot control device 30 can highly accurately perform the work of applying the external force in the direction different from the direction parallel to the direction in which the first target object O1 is displaced, based on the displacement actuation that includes at least one of the first actuation, the second actuation, the third actuation, and the fourth actuation. In addition, the robot control device 30 can highly accurately perform the work of applying the external force in the direction different from the direction parallel to the direction in which the first target object O1 is displaced, based on the actuation on the basis of some or all of the first actuation, the second actuation, the third actuation, and the fourth actuation.

The displacement actuation, which the robot control device 30 causes the robot 20 to perform, is determined depending on the respective values of the coefficients C expressed in Equation (8). In addition, the respective values of the coefficients C are determined depending on the work which the robot control device 30 causes the robot 20 to perform. Hence, the robot control device 30 causes the robot 20 to perform the displacement actuation depending on the work. In this manner, the robot control device 30 can cause the robot 20 to highly accurately perform the work of applying the external force in the direction different from the direction parallel to the direction in which the first target object O1 is displaced, based on the displacement actuation depending on the predetermined work.

In other words, since at least some of the coefficients C contained in a non-diagonal component of the matrix in Equation (8) are finite values without 0 under the force control in the example, the robot control device 30 can cause the robot 20 to perform the displacement actuation of displacing the first target object O1 in the direction different from the direction of the external force among the plurality of directions. The diagonal components of the matrix are the submatrix M11, the submatrix M22, the submatrix M33, the submatrix M44, the submatrix M55, and the submatrix M66 in the matrix, and the non-diagonal components of the matrix are the submatrices other than the above submatrices of the matrix. In other words, the matrix is an example of a matrix indicating the displacement actuation.

### Modification Example of Embodiment

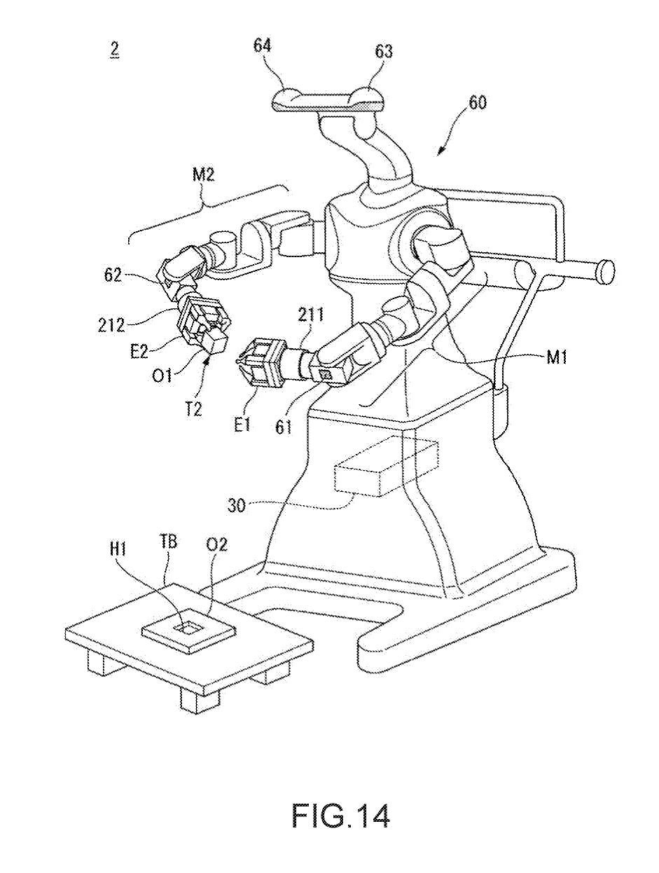

Hereinafter, a modification example of the embodiment will be described with reference to the FIG. 14. Note that, in the modification example of the embodiment, the same reference signs are assigned to the same configurational components as those in the embodiment, and thus the description thereof is omitted.

FIG. 14 is a diagram illustrating an example of a configuration of a robot system 2 according to the modification example of the embodiment. The robot system 2 includes a robot 60 in which the internal robot control device 30 is installed.

The robot 60 is a dual-arm robot that includes a first arm, a second arm, a support base which supports the first arm and the second arm, and the robot control device 30. Note that the robot 60 may be a multi-arm robot that includes three or more arms, instead of the dual-arm robot.

The first arm includes a first end effector E1, a first manipulator Ml, and a force detector 211.

The first end effector E1 in the example is an end effector that includes a finger portion which is capable of gripping an object. Note that the first end effector E1 may be an end effector that is capable of holding an object by suction of air, magnetic force, a jig, or the like, or another end effector, instead of the end effector including the finger portion.

The first end effector E1 is connected to the robot control device 30 via a cable so as to be capable of communicating with the robot control device. In this manner, the first end effector E1 is actuated based on a control signal acquired from the robot control device 30. Note that the wired communication via the cable is performed in accordance with the standards such as the Ethernet (registered trademark) or a USB. In addition, the first end effector E1 may be configured to be connected to the robot control device 30 through wireless communication that is performed in accordance with the communication standards such as Wi-Fi (registered trademark).

The first manipulator Ml includes seven joints and a first imaging unit 61. In addition, the seven joints include respective actuators (not illustrated). In other words, the first arm including the first manipulator Ml is a seven-axis vertical multijoint type of arm. The first arm is actuated in a degree of freedom of seven axes through actuation performed in cooperation with the support base, the first end effector E1, the first manipulator M1, and the respective actuators of the seven joints included in the first manipulator M1. Note that the first arm may be configured to be actuated in a degree of freedom of six or less axes, or may be configured to be actuated in a degree of freedom of eight or more axes.

In a case where the first arm is actuated in the degree of freedom of seven axes, the first arm has an increase in postures which are acquired, compared to a case of the actuation in the degree of freedom of six or less axes. In this manner, the first arm smoothly is actuated and further it is possible to easily avoid interference with an object present around the first arm. In addition, in a case where the first arm is actuated in the degree of freedom of seven axes, a computing amount is reduced and it is easy to control the first arm, compared to a case where the first arm is actuated in the degree of freedom of eight or more axes.

The seven actuators (included in the respective joints) which are included in the first manipulator Ml are connected to the robot control device 30 via respective cables, so as to be capable of communicating with the robot control device. In this manner, the actuators cause the first manipulator M1 to be actuated, based on a control signal acquired from the robot control device 30. Note that the wired communication via the cable is performed in accordance with the standards such as the Ethernet (registered trademark) or a USB. In addition, some or all of the seven actuators included in the first manipulator M1 may be configured to be connected to the robot control device 30 through wireless communication that is performed in accordance with the communication standards such as Wi-Fi (registered trademark).

The first imaging unit 61 is a camera that includes a charge coupled device (CCD), a complementary metal oxide semiconductor (CMOS), or the like, as an imaging element that converts condensed light into an electrical signal. In the example, the first imaging unit 61 is provided in a part of the first manipulator Ml. Therefore, the first imaging unit 61 moves depending on movement of the first arm. In addition, a range in which the first imaging unit 61 is capable of capturing images changes depending on the movement of the first arm. The first imaging unit 61 may be configured to capture still images in the range, or may be configured to capture moving images in the range.

In addition, the first imaging unit 61 is connected to the robot control device 30 via a cable so as to be capable of communicating with the robot control device. Note that the wired communication via the cable is performed in accordance with the standards such as the Ethernet (registered trademark) or a USB. Note that the first imaging unit 61 may be configured to be connected to the robot control device 30 through the wireless communication that is performed in accordance with the communication standards such as Wi-Fi (registered trademark).

The force detector 211 is provided between the first end effector E1 and the first manipulator M1. The force detector 211 has the same configuration as the force detector 21 and detects external force applied to a control target in the first arm. The control target in the first arm in the example is the first end effector E1 or an object gripped by the first end effector E1 in some cases. The force detector 211 outputs, to the robot control device 30 through the communication, first force-detection information including, as output values, values indicating types of detected external force.

The first force-detection information is used in the force control by the robot control device 30, as control performed based on the first force-detection information of the first arm. The force control means the force control described in the embodiment. Note that the force detector 211 may be another sensor such as a torque sensor that detects a value indicating external force applied to the control target.

The force detector 211 is connected to the robot control device 30 via a cable so as to be capable of communicating with the robot control device. For example, the wired communication via the cable is performed in accordance with the standards such as the Ethernet (registered trademark) or a USB. Note that the force detector 211 and the robot control device 30 may be configured to be connected to each other through the wireless communication that is performed in accordance with the communication standards such as Wi-Fi (registered trademark).

The second arm includes a second end effector E2, a second manipulator M2, and a force detector 212.

The second end effector E2 in the example is an end effector that includes a finger portion which is capable of gripping an object. Note that the second end effector E2 may be an end effector that is capable of holding an object by suction of air, magnetic force, a jig, or the like, or another end effector, instead of the end effector including the finger portion.

The second end effector E2 is connected to the robot control device 30 via a cable so as to be capable of communicating with the robot control device. In this manner, the second end effector E2 is actuated based on a control signal acquired from the robot control device 30. Note that the wired communication via the cable is performed in accordance with the standards such as the Ethernet (registered trademark) or a USB. In addition, the second end effector E2 may be configured to be connected to the robot control device 30 through wireless communication that is performed in accordance with the communication standards such as Wi-Fi (registered trademark).

The second manipulator M2 includes seven joints and a second imaging unit 62. In addition, the seven joints include respective actuators (not illustrated). In other words, the second arm including the second manipulator M2 is the seven-axis vertical multijoint type of arm. The second arm is actuated in a degree of freedom of seven axes through the actuation performed in cooperation with the support base, the second end effector E2, the second manipulator M2, and the respective actuators of the seven joints included in the second manipulator M2. Note that the second arm may be configured to be actuated in a degree of freedom of six or less axes, or may be configured to be actuated in a degree of freedom of eight or more axes.

In a case where the second arm is actuated in the degree of freedom of seven axes, the second arm has an increase in postures which are acquired, compared to a case of the actuation in the degree of freedom of six or less axes. In this manner, the second arm smoothly performs the actuation and further it is possible to easily avoid interference with an object present around the second arm. In addition, in a case where the second arm is actuated in the degree of freedom of seven axes, a computing amount is reduced and it is easy to control the second arm, compared to a case where the second arm is actuated in the degree of freedom of eight or more axes.

The seven actuators (included in the respective joints) which are included in the second manipulator M2 are connected to the robot control device 30 via respective cables, so as to be capable of communicating with the robot control device. In this manner, the actuators actuate the second manipulator M2, based on the control signal acquired from the robot control device 30. Note that the wired communication via the cable is performed in accordance with the standards such as the Ethernet (registered trademark) or a USB. In addition, some or all of the seven actuators included in the second manipulator M2 maybe configured to be connected to the robot control device 30 through the wireless communication that is performed in accordance with the communication standards such as Wi-Fi (registered trademark).

The second imaging unit 62 is a camera that includes a CCD, a CMOS, or the like, as an imaging element that converts condensed light into an electrical signal. In the example, the second imaging unit 62 is provided in a part of the second manipulator M2. Therefore, the second imaging unit 62 moves depending on movement of the second arm. In addition, a range in which the second imaging unit 62 is capable of capturing images changes depending on the movement of the second arm. The second imaging unit 62 may be configured to capture still images in the range, or may be configured to capture moving images in the range.

In addition, the second imaging unit 62 is connected to the robot control device 30 via a cable so as to be capable of communicating with the robot control device. For example, the wired communication via the cable is performed in accordance with the standards such as the Ethernet (registered trademark) or a USB. Note that the second imaging unit 62 may be configured to be connected to the robot control device 30 through the wireless communication that is performed in accordance with the communication standards such as Wi-Fi (registered trademark).

The force detector 212 is provided between the second end effector E2 and the second manipulator M2. The force detector 212 has the same configuration as the force detector 21 and detects external force applied to a control target in the second arm. The control target in the second arm in the example is the second end effector E2 or an object gripped by the second end effector E2 in some cases. The force detector 212 outputs, to the robot control device 30 through the communication, second force-detection information including, as output values, values indicating types of detected external force. Hereinafter, as an example, a case where the first target object O1 gripped by the second end effector E2 in advance is the control target in the second arm will be described.

The second force-detection information is used in the force control by the robot control device 30, as control performed based on the second force-detection information of the second arm. The force control means the force control described in the embodiment. Note that the force detector 212 may be another sensor such as a torque sensor that detects a value indicating external force applied to the control target.

The force detector 212 is connected to the robot control device 30 via a cable so as to be capable of communicating with the robot control device. For example, the wired communication via the cable is performed in accordance with the standards such as the Ethernet (registered trademark) ora USB. Note that the force detector 212 and the robot control device 30 may be configured to be connected to each other through the wireless communication that is performed in accordance with the communication standards such as Wi-Fi (registered trademark).

In addition, the robot 60 includes a third imaging unit 63 and a fourth imaging unit 64.

The third imaging unit 63 is a camera that includes a CCD, a CMOS, or the like, as an imaging element that converts condensed light into an electrical signal. The third imaging unit 63 is provided in a region in which it is possible to perform, along with the fourth imaging unit 64, stereo imaging of a range in which the fourth imaging unit 64 is capable of capturing images. The third imaging unit 63 is connected to the robot control device 30 via a cable so as to be capable of communicating with the robot control device. For example, the wired communication via the cable is performed in accordance with the standards such as the Ethernet (registered trademark) or a USB. Note that the third imaging unit 63 may be configured to be connected to the robot control device 30 through the wireless communication that is performed in accordance with the communication standards such as Wi-Fi (registered trademark).

The fourth imaging unit 64 is a camera that includes a CCD, a CMOS, or the like, as an imaging element that converts condensed light into an electrical signal. The fourth imaging unit 64 is provided in a region in which it is possible to perform, along with the third imaging unit 63, the stereo imaging of the range in which the third imaging unit 63 is capable of capturing images. The fourth imaging unit 64 is connected to the robot control device 30 via a cable so as to be capable of communicating with the robot control device. For example, the wired communication via the cable is performed in accordance with the standards such as the Ethernet (registered trademark) or a USB. Note that the fourth imaging unit 64 may be configured to be connected to the robot control device 30 through the wireless communication that is performed in accordance with the communication standards such as Wi-Fi (registered trademark).

Functional elements included in the robot 60 described above acquire control signals from the internal robot control device 30 installed in the robot 60 in the example.

The functional elements are actuated based on the acquired control signal. Note that the robot 60 may be configured to be controlled by the robot control device 30 that is externally installed, instead of the configuration of the internal robot control device 30. In this case, the robot 60 and the robot control device 30 configure the robot system. In addition, the robot 60 may have a configuration in which some or all of the first imaging unit 61, the second imaging unit 62, the third imaging unit 63, and the fourth imaging unit 64 are not provided.

In the example, a control point T2 is set at the center of gravity of the first target object O1. In other words, the robot control device 30 in the example performs, on at least one of the first arm and the second arm, the same force control as the force control of the arm A in the embodiment by the robot control device 30. In the example, since the first target object O1 is gripped by the second arm, the robot control device 30 actuates the second arm by the force control in the example such that it is possible for the second arm to perform the same predetermined work as in the embodiment. Note that, in a case where the first target object O1 is gripped by the first arm, the robot control device 30 actuates the first arm by the force control in the example such that it is possible for the first arm to perform the same predetermined work as in the embodiment . In this manner, in a case where the force detector (in the example, the force detector 211 or the force detector 212) detects external force, the robot control device 30 causes the robot 60 to perform the displacement actuation of displacing the control target (in the example, the first target object O1) in the direction different from the direction of the external force among the plurality of directions. In this manner, similar to the embodiment, the robot control device 30 can highly accurately perform the work of applying the external force in the direction different from the direction parallel to the direction in which the control target is displaced.

In the embodiment described above, the case where the robot control device 30 performs the force control on the basis of Equation (8) based on the motion equation converted into the digital filter is described; however, the robot control device 30 may be configured to perform the same force control as the force control described in the embodiment on the basis of the motion equation expressed by Equation (1). In this case, the robot control device 30 solves the six motion equations according to the X translational force, the Y translational force, the Z translational force, the W rotation moment, the V rotation moment, and the U rotation moment of the external force detected by the force detector 21 (or the force detector 211 or the force detector 212), and thereby it is possible to calculate the translational displacement amounts and the rotational displacement amounts depending on the six types of force and moment.

Equations (2) to (7) are an example of the translational displacement amounts and the rotational displacement amounts. In other words, Equation (2) is for the TTX translational displacement amount due to the X translational force, Equation (3) is for the TTY translational displacement amount due to the X translational force, and Equation (4) is for the TTZ translational displacement amount due to the X translational force. In addition, Equation (5) is for the TRW rotational displacement amount due to the X translational force, Equation (6) is for the TRV rotational displacement amount due to the X translational force, and Equation (7) is for the TRU rotational displacement amount due to the X translational force. Note that the six motion equations according to the Y translational force, the Z translational force, the W rotation moment, the V rotation moment, and the U rotation moment can be derived in the same method as the method of deriving the six motion equations according to the X translational force, and thus the description thereof is omitted.

The robot control device 30 solves the six motion equations according to the X translational force, the Y translational force, the Z translational force, the W rotation moment, the V rotation moment, and the U rotation moment, and thereby the translational displacement amounts and the rotational displacement amounts depending on the six types of force and moment are calculated. In addition, the respective amounts of the X translational displacement amount, the Y translational displacement amount, the Z translational displacement amount, the W rotational displacement amount, the V rotational displacement amount, and the U rotational displacement amount are calculated based on the calculated translational displacement amounts and rotational displacement amounts. The robot control device 30 changes the position and the posture of the control point T2, based on the current position and posture of the control point T2, the respective amounts of the X translational displacement amount, the Y translational displacement amount, the Z translational displacement amount, the W rotational displacement amount, the V rotational displacement amount, and the U rotational displacement amount. In this manner, the robot control device 30 can achieve the same effects as those in the embodiment.

As described above, in a case where the force detector (in the example, the force detector 21) detects external force, the robot control device 30 causes the robot 20 to perform the displacement actuation of displacing the control target (in the example, the first target object O1) in the direction different from the direction of the external force among the plurality of directions. In this manner, the robot control device 30 may cause the robot 20 to highly accurately perform the work of applying the external force in the direction different from the direction parallel to the direction in which the control target is displaced.

In addition, in a case where the robot 20 is caused to perform the predetermined work (in the example, the chamferless fitting work of the first target object O1 into the second target object O2), the robot control device 30 causes the robot 20 to perform the displacement actuation depending on the predetermined work. In this manner, the robot control device 30 can cause the robot 20 to highly accurately perform the work of applying the external force in the direction different from the direction parallel to the direction in which the control target is displaced, based on the displacement actuation depending on the predetermined work.

In addition, the robot control device 30 causes the robot 20 to perform, as the predetermined work, the work of fitting the first target object (in the example, the first target object O1) into the second target object (in the example, the second target object O2) into which the first target object is fitted. In this manner, the robot control device 30 can cause the robot 20 to highly accurately perform the work of applying the external force in the direction different from the direction parallel to the direction in which the control target is displaced, based on the displacement actuation depending on the work of fitting the first target object into the second target object.

In addition, in the case where the force detector detects the external force, the robot control device 30 causes the robot 20 to perform the displacement actuation that includes at least one of the first actuation, the second actuation, the third actuation, and the fourth actuation, as the displacement actuation of displacing the control target in the direction different from the direction of the external force among the plurality of directions. In this manner, the robot control device 30 can cause the robot 20 to highly accurately perform the work of applying the external force in the direction different from the direction parallel to the direction in which the control target is displaced, based on the displacement actuation that includes at least one of the first actuation, the second actuation, the third actuation, and the fourth actuation.

In addition, the robot control device 30 causes the robot 20 to perform, as the displacement actuation, the actuation based on some or all of the first actuation, the second actuation, the third actuation, and the fourth actuation. In this manner, the robot control device 30 can cause the robot 20 to highly accurately perform the work of applying the external force in the direction different from the direction parallel to the direction in which the control target is displaced, based on the actuation on the basis of some or all of the first actuation, the second actuation, the third actuation, and the fourth actuation.

In addition, the robot control device 30 causes the robot 20 to perform the displacement actuation based on the result obtained from the matrix (in the example, the matrix expressed in Equation (8)) operation of the digital filter. In this manner, the robot control device 30 can cause the robot 20 to highly accurately perform the work of applying the external force in the direction different from the direction parallel to the direction in which the control target is displaced, based on the result obtained from the matrix operation of the digital filter.

As described above, the embodiment of the invention is described in detail with reference to the figures; however, a specific configuration is not limited to the embodiment, and modification, replacement, removal, or the like may be performed without departing from the gist of the invention.

In addition, a program for executing a function of any configurational element in the device (for example, the robot control device 30) described above may be recorded in a computer-readable recording medium, or the program may be read and executed by a computer system. Note that, the “computer system” includes an operating system (OS) or hardware such as peripheral equipment. In addition, the “computer-readable recording medium” means a portable medium such as a flexible disk, a magneto-optical disk, a ROM, or a compact disk (CD) -ROM, or a storage device such as a hard disk installed in the computer system. Further, the “computer-readable recording medium” includes a medium that temporarily stores a program, such as a volatile memory (RAM) in the computer system as a server or a client in a case where the program is transmitted via a network such as Internet or a communication line such as a telephone line.

In addition, the program described above may be transmitted to anther computer system from the computer system in which the program is stored in the storage device or the like, via a transmission medium or through transmission waves of the transmission medium. Here, the “transmission medium” that transmits the program means a medium that has a function of transmitting information via the network (communication network) such as the Internet or the communication line such as the telephone line.

In addition, the program described above may be for realizing some of the functions described above. Further, the program described above may be able to realize the functions described above by being combined with a program stored in advance in the computer system or may be a difference file (difference program).

The entire disclosure of Japanese Patent Application No. 2016-149432, filed Jul. 29, 2016 is expressly incorporated by reference herein.

What is claimed is:

1. A robot control device comprising:
a processor that is configured to execute computer-executable instruction so as to control a robot that is capable of displacing a control target of a robot in a plurality of directions,
wherein the processor is configured to cause the robot to perform displacement actuation of displacing the control target in a direction different from a direction of the external force among the plurality of directions in a case where a force detector detects external force.

2. The robot control device according to claim 1,
wherein the processor is configured to cause the robot to perform the displacement actuation depending on the predetermined work in a case where the robot is caused to perform predetermined work.

3. The robot control device according to claim 2,
wherein the processor is configured to cause the robot to perform, as the predetermined work, work of fitting a first target object into a second target object into which the first target object is fitted.

4. The robot control device according to claim 1,
wherein the displacement actuation includes at least one of first actuation of translating the control target based on translational force of the external force, second actuation of rotating the control target based on the translational force, third actuation of translating the control target based on rotation moment of the external force, and fourth actuation of rotating the control target based on the rotation moment.

5. The robot control device according to claim 4,
wherein the processor is configured to cause the robot to perform, as the displacement actuation, actuation based on some or all of the first actuation, the second actuation, the third actuation, and the fourth actuation.

6. The robot control device according to claim 1,
wherein the processor is configured to cause the robot to perform the displacement actuation based on a result obtained from a matrix operation of a digital filter.

7. A robot,
wherein the robot is controlled by the robot control device according to claim 1.

8. A robot,
wherein the robot is controlled by the robot control device according to claim 2.

9. A robot,
wherein the robot is controlled by the robot control device according to claim 3.

10. A robot,
wherein the robot is controlled by the robot control device according to claim 4.

11. A robot,
wherein the robot is controlled by the robot control device according to claim 5.

12. A robot,
wherein the robot is controlled by the robot control device according to claim 6.
